(19) United States
(12) Patent Application Publication
(10) Pub. No.: US 2022/0295703 A1
(43) Pub. Date: Sep. 22, 2022

(54) BAGGING APPARATUS FOR HIGH-EFFICIENCY LAWN MAINTENANCE TOOL

(71) Applicant: MTD PRODUCTS INC, Valley City, OH (US)

(72) Inventors: Axel Schaedler, Olmsted Falls, OH (US); Adam Hiller, Jeromesville, OH (US)

(21) Appl. No.: 17/700,255

(22) Filed: Mar. 21, 2022

Related U.S. Application Data
(60) Provisional application No. 63/163,386, filed on Mar. 19, 2021.

(51) Int. Cl. A01D 34/82; A01D 34/00; A01D 34/66; A01D 34/73; A01D 34/78; A01D 34/81; A01D 42/06; A01D 43/063

(52) U.S. Cl. CPC A01D 34/826; A01D 34/008; A01D 34/664; A01D 34/733; A01D 34/78; A01D 34/81; A01D 42/06; A01D 43/0636; A01D 2034/6825

(57) ABSTRACT

A high efficiency turf maintenance apparatus having low power consumption and good cutting performance including a bagging apparatus for turf clippings is presented herein. A blade configuration is disclosed to provide lift and to propel turf clippings from a mow deck to the bagging apparatus. Further, the blade configuration can be implemented with minimal increase in power consumption, allowing the bagging apparatus to be utilized with an electric motor power source with little or no impact on battery life.

### CROSS-REFERENCE TO RELATED APPLICATION

This application for patent claims the benefit of priority from U.S. Provisional Patent Application No. 63/163,386 filed Mar. 19, 2021, which is hereby incorporated by reference herein in its entirety and for all purposes.

### INCORPORATION BY REFERENCE

The following are hereby incorporated by reference within the present disclosure in their respective entireties and for all purposes: U.S. patent application Ser. No. 15/174,738 filed Jun. 6, 2016; U.S. Provisional Application No. 62/171,475 filed Jun. 5, 2015; U.S. Provisional Application No. 62/325,490 filed Apr. 21, 2016; U.S. Pat. No. 10,212,880 issued Feb. 26, 2019; International Patent Application No. PCT/US2017/039315 filed Jun. 26, 2017; U.S. Provisional Application No. 62/354,198 filed Jun. 24, 2016, U.S. Pat. No. 10,806,076 issued Oct. 20, 2020; U.S. patent application Ser. No. 16/152,440 filed Oct. 5, 2018 and U.S. Provisional Application No. 62/569,078 filed Oct. 6, 2017.

### FIELD OF DISCLOSURE

The disclosed subject matter pertains to a battery powered electric power equipment device with a bagging system for collection of turf clippings.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure provide a high efficiency turf maintenance apparatus having low power consumption and good cutting performance even in thick turf. A bagging apparatus is provided in various embodiments to collect and store turf clippings. A blade configuration is disclosed to provide lift and to propel turf clippings from a mow deck to the bagging apparatus. Further, the blade configuration can be implemented with minimal increase in power consumption, allowing the bagging apparatus to be utilized with an electric motor power source with little or no impact on battery life.

In an embodiment, disclosed is a grass mowing apparatus comprising a frame, a plurality of front wheels and a plurality of rear wheels secured to the frame. The grass mowing apparatus can comprise a mow deck secured to the frame and a blade apparatus secured to the mow deck and secured to a plurality of blades. The blade apparatus can be configured to drive motion of the plurality of blades within an interior of the mow deck in response to a force applied to the blade apparatus. In further embodiments, the grass mowing apparatus can comprise an electric motor coupled to the blade apparatus and configured to supply the force to the blade apparatus and a discharge chute opening on a side of the mow deck defining an opening within the mow deck. Further, the grass mowing apparatus can comprise a bagging assembly connected to the grass mowing apparatus comprising a chute portion positioned within the discharge chute opening for guiding material from an interior of the mow deck into the bagging assembly, and a bag portion coupled to the chute portion for receiving the material guided by the chute portion.

In a further embodiment, a blade assembly is disclosed for an electric-powered walk behind mowing machine with bagging assembly for collecting grass clippings of the mowing machine. The blade assembly can comprise a central portion configured to rotate about a central axis of the central portion and includes a plurality of blade connectors comprising a first blade connector configured to be hand-secured to a removable blade. Further, the blade assembly can comprise a cutting blade connected to the first blade connector and having a length dimension extending from the central portion toward a perimeter defined by a non-secured end of the cutting blade opposite the connection to the first blade connector, and having a width dimension substantially transverse to a rotational direction that the central portion rotates about the central axis, wherein the width dimension defines a tilt about the length dimension of smaller than about ten degrees. In addition to the foregoing, the blade assembly can comprise a cutting lift blade connected to a second blade connector of the plurality of blade connectors and having the length dimension and the width dimension, wherein the width dimension of the cutting lift blade defines a second tilt about the length dimension of greater than about fifteen degrees.

In addition to the foregoing, disclosed is a power equipment device. The power equipment device can comprise a frame, a plurality of front wheels and a plurality of rear wheels secured to the frame, and a mow deck secured to the frame. Further, the power equipment device can comprise a blade apparatus secured to the mow deck and configured to drive a plurality of blades within an interior of the mow deck in response to a force applied to the blade apparatus. The power equipment device can additionally comprise an electric motor coupled to the blade apparatus and configured to supply the force to the blade apparatus, and a handle secured to the frame, the handle configured to fold down over the mow deck and the frame. Still further, the power equipment device can comprise a lift mechanism configured to raise and lower at least the mow deck and the frame (and the blade apparatus and electric motor in some embodiments) relative to the front wheels and rear wheels. In various embodiments, the left mechanism can comprise a left-right mechanical coupling located proximate the rear wheels that couples a left-side of the lift mechanism with a right-side of the lift mechanism and causes the left-side and right-side of the lift mechanism to move together, and a single lift handle to raise or lower the lift mechanism and the mow deck and frame concurrently. In some embodiments, the power equipment device is contained within a volume defined by the diameters of the front wheels and rear wheels, in response to the lift mechanism positioned to a compact position and the handle folded over the mow deck.

In yet another embodiment(s), the subject disclosure provides a bagging assembly for a walk-behind lawn mower. The bagging assembly can comprise a chute that removably couples to a mow deck of the walk-behind lawn mower for guiding clippings from an interior of the mow deck out of the mow deck. In one or more embodiments, the chute can include a bottom portion and a top portion. The bottom portion can have a front opening that receives the clippings and a rear guide surface that is curved in a direction transverse to or approximately transverse to a flow of the clippings from the mow deck through the chute, and the top portion can have a flat surface. Still further, the bagging assembly can comprise a bag coupled to the chute to receive the clippings guided by the chute, the bag including a front portion, a rear portion, a grass flow diverter, a dump opening and a dump lid. In some embodiments, the chute can be configured to guide the clippings to the rear portion of the bag and the grass flow diverter can include a baffle that physically redirects flow of a portion of the clippings guided by the chute to the front portion of the bag. In another embodiment, the dump opening can define a hole in the bag and the dump lid can cover the hole when the bagging assembly is coupled to the walk-behind lawn mower, and can uncover the hole in response to the dump lid being lifted away from the bag. In still other embodiments, the dump lid can include a transparent cover that facilitates view of an interior portion of the bag in response to the dump lid covering the hole.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an illustration of an interior of a mow deck and blade assembly of a high efficiency outdoor maintenance apparatus according to aspects disclosed herein.

FIG. 2 depicts a high efficiency outdoor maintenance apparatus including a bagging assembly according to embodiments of the present disclosure.

FIG. 3 depicts a cutting blade and lift blade for a disclosed blade assembly according to additional embodiments.

FIG. 4 illustrates a bagging apparatus for a high efficiency outdoor maintenance apparatus in another embodiment(s).

FIG. 5 illustrates a bagging apparatus including a chute and a bag assembly with view window, according to still further embodiments.

FIG. 6 depicts a bagging apparatus having a plurality of lift handles, in additional embodiments.

FIG. 7 illustrates a high efficiency outdoor maintenance apparatus according to additional embodiments disclosed herein.

FIG. 7A depicts a diagram of an example mowing apparatus with bagging assembly resting partly on a mow deck of the mowing apparatus, in an embodiment(s).

FIG. 8 depicts an example mowing deck with a discharge opening.

FIG. 8A depicts a sample diagram of clipping flow associated with the discharge opening of FIG. 8, in various embodiments.

FIG. 9 illustrates an interior of a mow deck with a bagging chute situated in a discharge opening of the mow deck, in one or more embodiments.

FIG. 10 illustrates an example of a chute for a bagging assembly in further disclosed embodiments.

FIG. 11 illustrates a rear portion of a chute for a bagging assembly and mechanical geometries associated with clipping flow, in an embodiment.

FIG. 12 depicts a portion of a bagging assembly including a grass flow diverter according to additional embodiments of the present disclosure.

FIGS. 12A and 12B illustrate a clipping flow diagram and clipping fill for the grass flow diverter of FIG. 12.

FIG. 12C illustrates an interior view of the grass flow diverter of FIG. 12 in a further embodiment.

FIG. 13 illustrates a bagging assembly for a lawn maintenance device with a transparent view window, in additional embodiments.

FIGS. 14, 14A, 14B and 14C illustrate a left mechanism for raising and lowering a mow deck of a disclosed high efficiency lawn maintenance apparatus, in further embodiments.

FIG. 14D depicts a compact position for a high efficiency lawn maintenance apparatus according to still other embodiments of the present disclosure.

FIG. 15 depicts an example mow deck facilitating high efficiency mowing operation according to embodiments of the present disclosure.

FIG. 16 illustrates a sample mow deck interior to facilitate rapid ejection of clippings to improve mowing efficiency, in further embodiments.

FIG. 17 illustrates an example lawn maintenance apparatus having a mower body that integrates a mow deck with structural support, in further embodiments.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to machine vision systems for power equipment machines are described herein, it should be understood that the disclosed machines, electronic and computing devices and methods are not so limited and modifications may be made without departing from the scope of the present disclosure. The scope of the systems, methods, and electronic and computing devices for machine vision devices are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

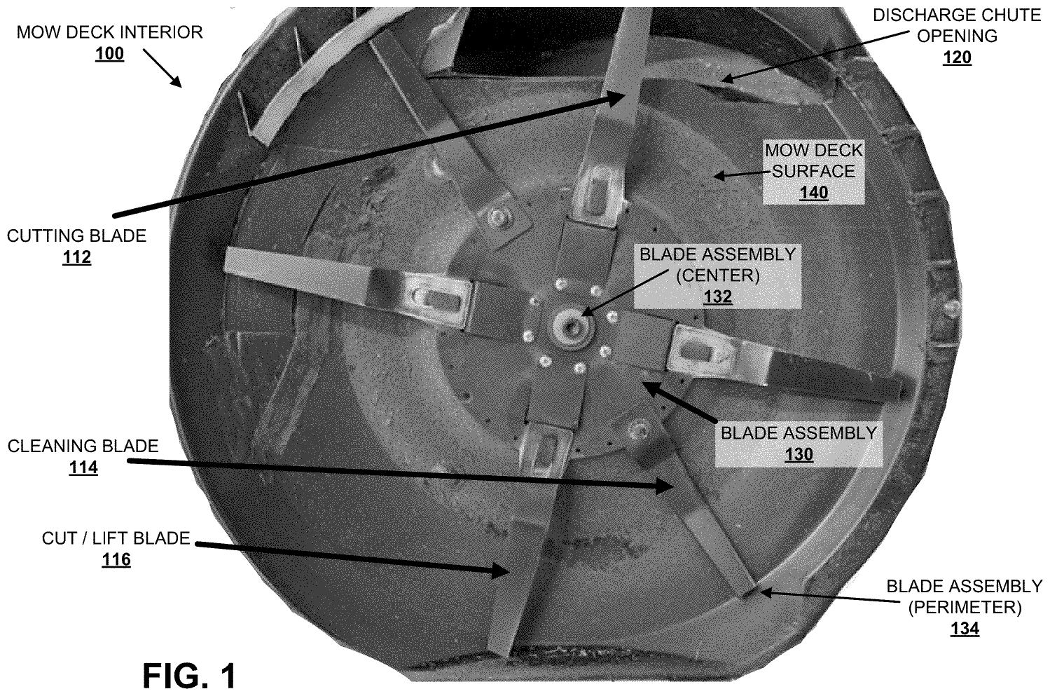

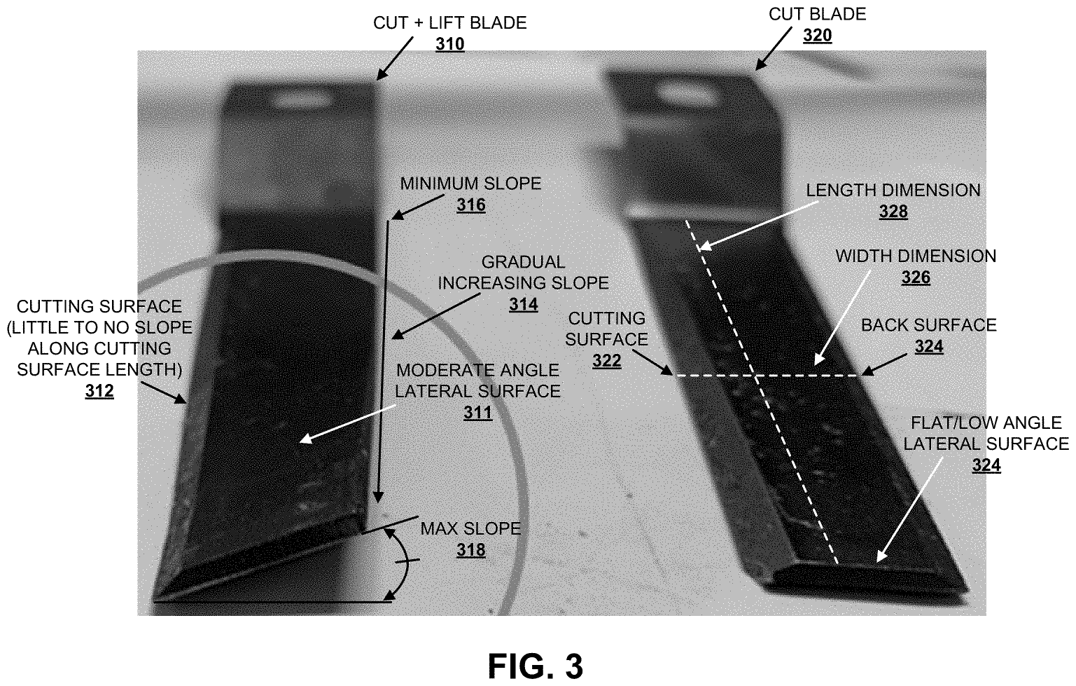

FIG. 1 provides an illustration of an example mow deck interior 100 for a high efficiency power equipment apparatus according to one or more embodiments of the present disclosure. Mow deck interior 100 includes a blade assembly for cutting grass, turf, foliage or other vegetation within mow deck interior 100. The blade assembly can include a cutting blade 112, a cleaning blade 114 and a cut/lift blade 116 in some disclosed embodiments. Each of the blades of the blade assembly includes a length dimension extending from a center 132 of the blade assembly toward a perimeter 134 of the blade assembly (near the outer edge of the mow deck) and includes a width dimension. The cutting blade 112 and cleaning blade 114 can have a relatively flat profile along the width dimension, whereas the cut and lift blade 116 can have a substantial tilt, rotation or twist in the width dimension (see, e.g., FIG. 3, infra) to generate moving air to create lift for the turf clippings, in various embodiments. The moving air and lift created by the cut/lift blade 116 can facilitate propulsion of turf clippings out of mow deck interior 100 to discharge chute opening 120.

FIG. 1 illustrates a single cut/lift blade 116 and three cutting blades 112. However, different numbers of cut/lift blades 116 and cutting blades 112 can be provided for disclosed blade assemblies, and different relative numbers of cut/lift blades 116 to cutting blades 112 can be provided in other embodiments. For instance, a disclosed blade assembly can include 2 cut/lift blades 116 and 2 cutting blades 112, 3 cut/lift blades 116 and 1 cutting blade, and so forth. Furthermore, the orientation of cut/lift blades 116 can be arranged symmetrically about blade assembly 130 or asymmetrically about blade assembly 130.

In some embodiments, cutting blade 112 and cleaning blade 114 can have a high-low orientation relative to mow deck surface 140. For instance, cutting blade 112 can extend downward away from mow deck surface 140 along a length of cutting blade 112, and cleaning blade 114 can extend upward toward mow deck surface 140 along a length of cleaning blade 114. While the embodiment of FIG. 1 illustrates two cleaning blades 114 and three cutting blades 112, different numbers of cleaning blades 114 (e.g., 0, 1, 2, 3, 4, . . . ) or cutting blades 112 (e.g., 0, 1, 2, 3, 4, . . . ) can be provided in different embodiments of the present disclosure.

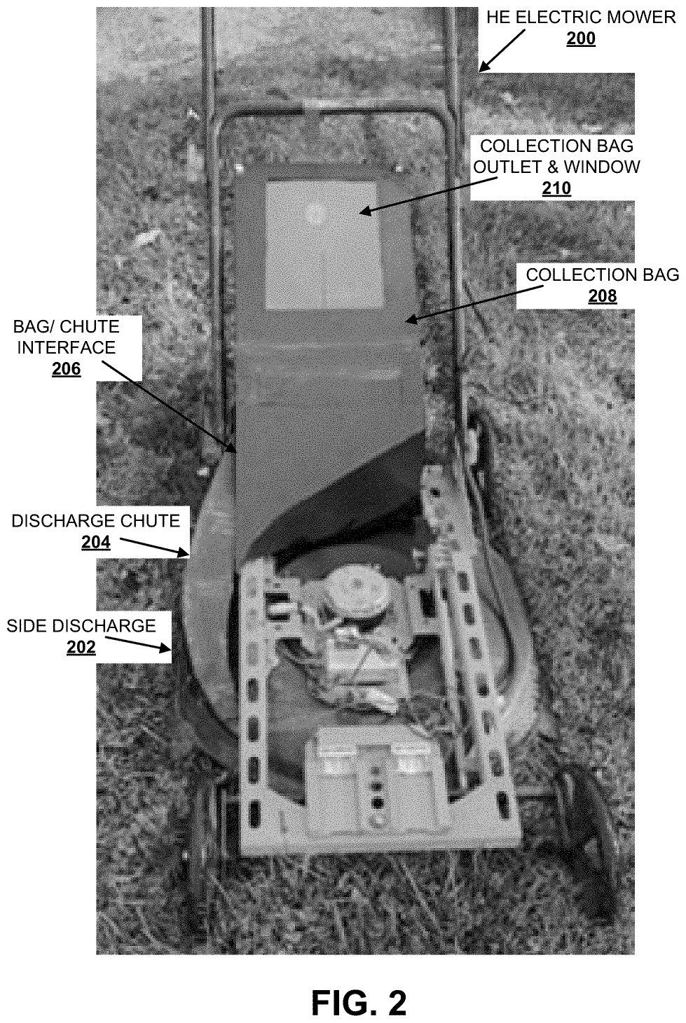

Mow deck interior 100 can also include a discharge chute opening 120 in the mow deck surface 140. The discharge chute opening 120 provides a path for turf clippings cut by cutting blade 112 or cut/lift blade 116 to exit mow deck interior 100 in a controlled manner. In an embodiment, a chute of a bagging assembly can be positioned in discharge chute opening 120 to collect the turf clippings and guide the turf clippings to a bagging assembly (not depicted, but see FIG. 2, infra).

FIG. 2 illustrates an example outdoor maintenance apparatus embodied as a high efficiency electric mower 200. In some embodiments, high efficiency electric mower 200 can have relatively low power consumption, allowing for only a small to moderate battery size yet a good run time. For instance, with a 21-inch radius mow deck 140 utilizing four cutting blades 112 (no cut/lift blades 116) with blade assembly 130 operating between about 2000 and about 2500 rotations per minute (rpm) in air (e.g., not cutting grass and therefore no friction or mechanical resistance on blade assembly 130 other than air), high efficiency electric mower 200 can consume less than 100 watts (W) of power in at least some disclosed embodiments. In other embodiments, power consumption can equal 300 W or less for a similar configuration cutting 1.5 inch grass, depending on environmental conditions such as grass moisture. When replacing one or more cutting blades 112 with a cut/lift blade 116, a significant amount of lift can be provided to turf clippings to propel clippings through side discharge 202, through flow chute 204 and into collection bag 208. This lift can be achieved with minimal impact on power consumption as well. For example, replacing two cutting blades 112 with two cut/lift blades 310 as configured in FIG. 3, infra, can result in less than 25 W of added power consumption compared to four cutting blades 112 (operating in air between about 2000 and 2500 rpm), while achieving substantial lift for turf clippings. In yet another embodiment, operating with two cut/lift blades 310 and two cutting blades 112 at reduced rpm (e.g., ˜1900 to ˜2100 rpm) achieves an excellent quality of cut, without any significant increase in power consumption compared with four cutting blades 112 operating at ˜2300 rpm. Accordingly, in some embodiments, addition of two cut/lift blades 310 to facilitate ejection of turf clippings into collection bag 208 can be implemented with no substantial increase in power consumption, and no reduction in quality of cut. Accordingly, the high efficiency electric mower 200 can cut moderate grass height at very low power consumption (1.5 inch cut at ˜200 W to ˜300 W) achieving long run times. For example, with a 252 watt-hour (Wh) battery, run times of just over 45 minutes can be achieved for moderate grass heights even in damp conditions.

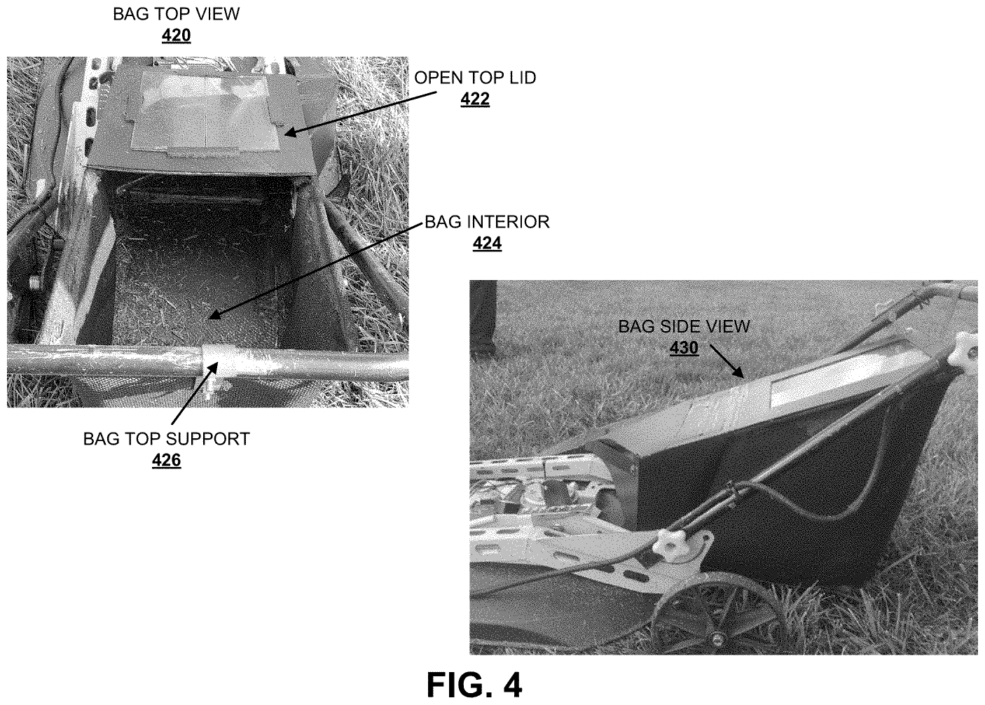

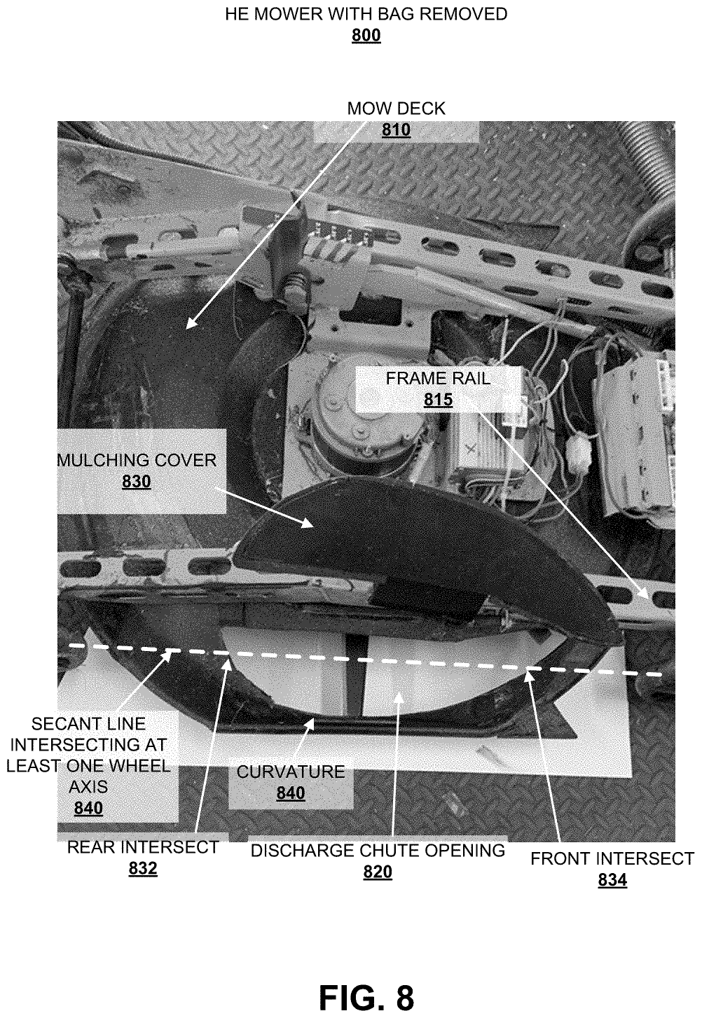

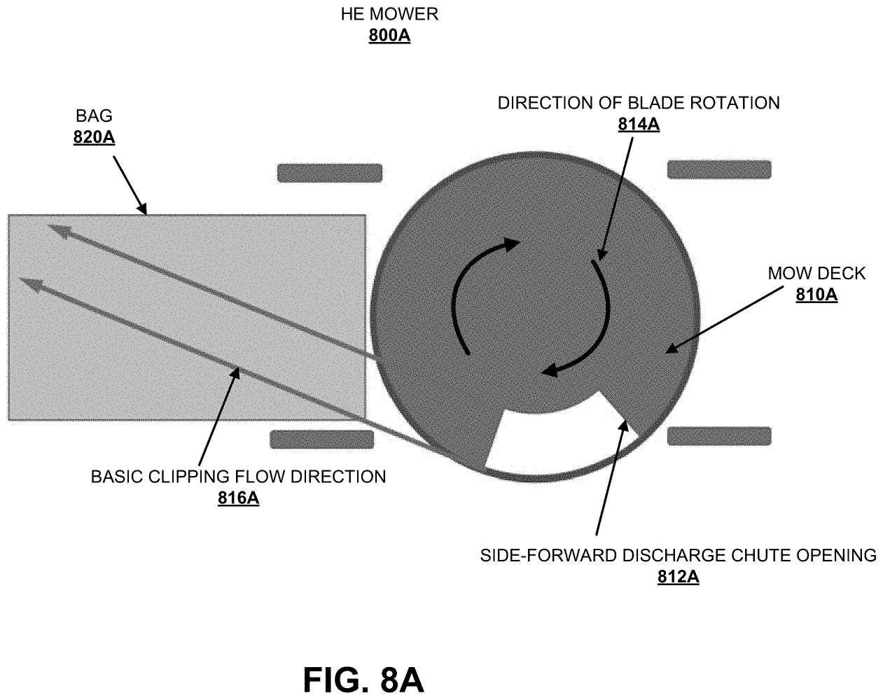

As illustrated by FIG. 2, the bagging system employed by high efficiency electric mower 200 includes a discharge flow chute 204 that extends along a side of the mow deck of high efficiency electric mower 200. Discharge chute 204 can extend as far forward as the front frame/mow deck overlap of high efficiency electric mower 200 and as far rearward to the rear frame/mow deck overlap (see FIG. 8, infra). Discharge chute 204 guides turf clippings to an interface 206 between discharge chute 204 and collection bag 208. In some embodiments, collection bag 208 and discharge chute 204 form a single solid piece; in other embodiments collection bag 208 can physically separate from discharge chute 204. A collection bag outlet and window 210 provide a larger output from collection bag 208 than an input to collection bag 208. The larger output allows clippings stored in collection bag 208 to be easily dumped from collection bag 208 out of a larger port than an opening (if any) defined by bag/chute interface 206 (or an input opening of discharge chute 204). In an embodiment, collection bag outlet and window 210 can define an opening spanning a width of collection bag 208 (e.g., see FIG. 4, infra) and a portion of the length of collection bag 208. In other embodiments, collection bag outlet and window 210 can define an opening smaller than the width of collection bag 208.

Collection bag outlet and window 210 includes a transparent portion allowing an operator to view an interior of collection bag 208 while collection bag outlet and window 210 are closed. This helps an operator determine when collection bag 208 is full, prior to clogging of discharge chute 204. By being able to visually inspect the contents of collection bag 208 while mowing, the operator can maximize mowing time and minimize time required to dump clippings from collection bag 208, while avoiding clogging of discharge chute 204. A size of the window portion of collection bag outlet and window 210 can be selected so that when the window is full, collection bag is 90 to 95% full, and therefore discharge chute 204 is not yet clogged with clippings. As one example, the window portion can be about 7 inches wide and about 9 inches long. In various embodiments, a range of sizes can be provided, including about 6 to 8 inches wide or any suitable value there between, or about 7 to 11 inches long or any suitable value there between, or a suitable combination of the foregoing.

FIG. 3 illustrates images of an example cut/lift blade 310 and an example cut blade 320 according to one or more embodiments of the present disclosure. Cut blade 320 includes a length dimension 328 and width dimension 326, the length dimension 328 extends from a coupling point with blade assembly 130 to an opposite end of cut blade 320, and the width dimension 326 extends perpendicular or approximately perpendicular to the length dimension 328 from cutting surface 322 to an opposing surface opposite cutting surface 322 along the width dimension 326. Cut blade 320 has a low angle or flat lateral surface 324 in the width dimension 326. The low angle can be less than an eleven-degree slope (e.g., where slope is depicted by the angle of max slope 318 with reference to cut/lift blade 310), less than a five-degree slope, or approximately zero slope, according to various embodiments. The low angle minimizes power consumption, but provides little to no lift for turf clippings.

Cut/lift blade 310 comprises a length dimension and width dimension similar to that illustrated for cut blade 320. Moreover, cut/lift blade 310 has a slope from its cutting surface 312 to its back surface, producing a moderate angle lateral surface 311. In an embodiment, the moderate angle lateral surface 311 can have a constant slope along its length dimension. In other embodiments, the moderate angle lateral surface 311 can have an increasing slope 314 from a first end to a second end. For instance, a minimum or zero slope 316 initiates at the end of the length dimension near connection to blade assembly 130 and increases in slope to a maximum slope 318 at the opposite end of the length dimension. These latter embodiments incorporating gradual slope along a length of cut/lift blade 310 can minimize increased power consumption of cut/lift blade 310 as compared with cut blade 320, decrease noise of cut/lift blade 310 in operation, and target the lifting force where most beneficial: at a periphery of the mow deck.

In an embodiment, the slope (e.g., max slope 318) of moderate angle lateral surface 311 can range from 17 to 25 degrees. In another embodiment, the slope can range from about 19 to about 23 degrees. In yet another embodiment, the slope can be about 21 degrees. In embodiments where cut/lift blade 310 comprises a gradual increasing slope 314, the above slope or ranges of slopes can be the max slope 318 at a furthest extent of the length dimension of cut/lift blade 310.

FIG. 4 depicts images of a top view 420 and side view 430 of collection bag 208 according to one or more embodiments. Bag top view 420 shows collection bag 208 with collection bag outlet and window 210 opened (open top lid 422), exposing a bag interior 424. Additionally, a bag top support 426 is shown that secures collection bag 208 to a handle of high efficiency electric mower 200.

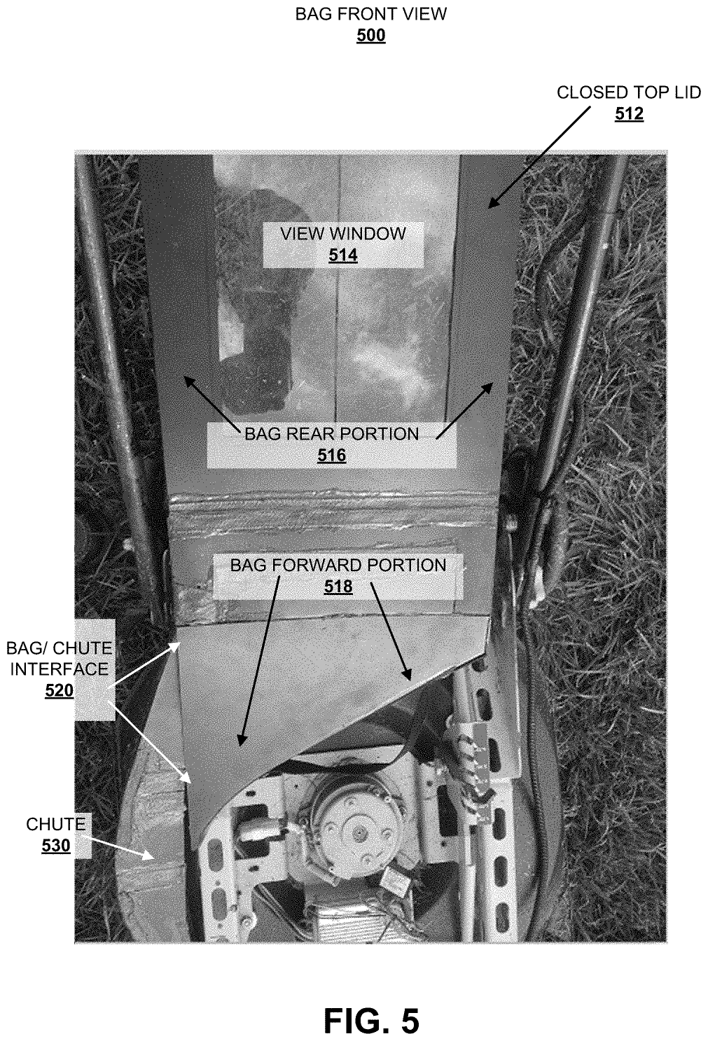

FIG. 5 illustrates a front view 500 of high efficiency electric mower 200. Chute 530 has a hollow interior connected to an interior of a collection bag at a bag/chute interface 520. The collection bag includes multiple portions, a bag forward portion 518 that rests upon a mow deck of the high efficiency electric mower 200. Further, a bag rear portion 516 is positioned behind the mow deck and can be supported from a handle of high efficiency electric mower 200, e.g., by way of bag top support 426. Closed top lid 512 includes view window 514 that allows an operator to gauge fullness of collection bag 208 while the lid is closed.

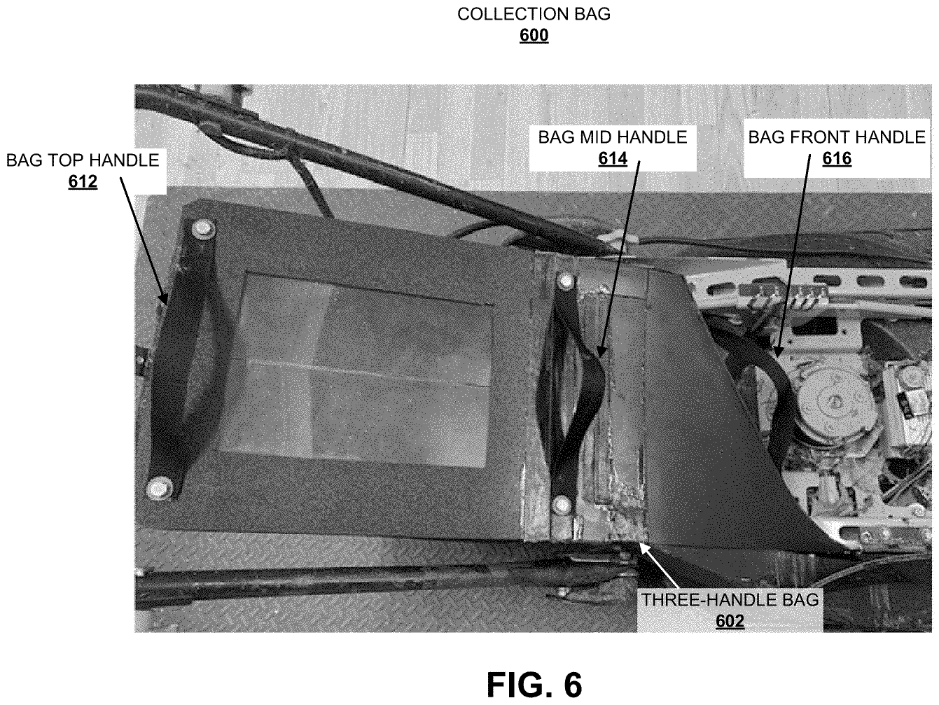

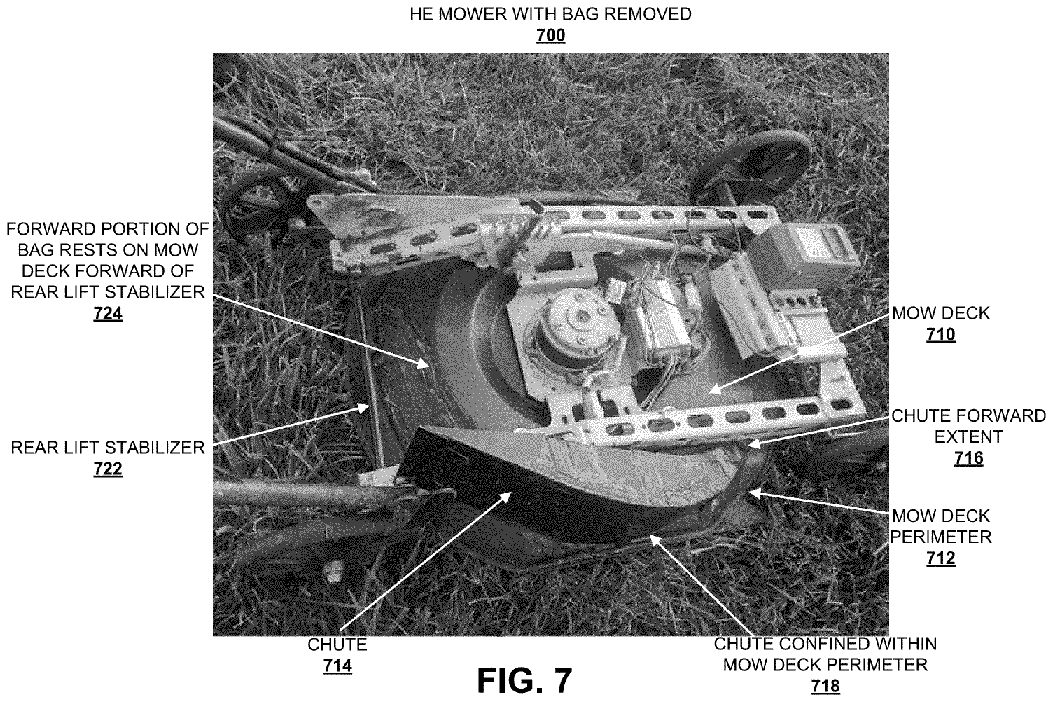

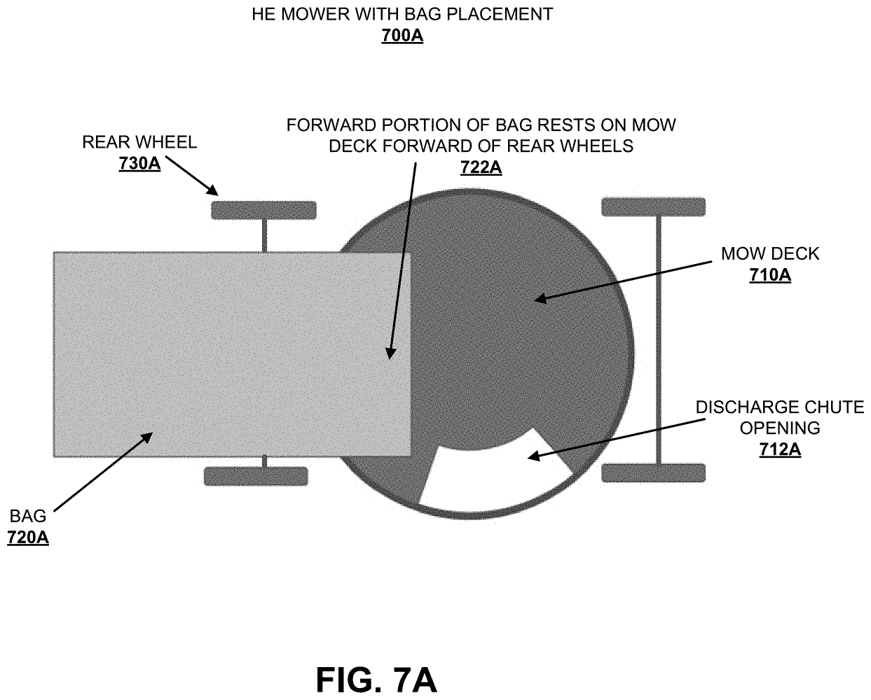

FIG. 6 depicts a collection bag 600 according to alternative or additional embodiments of the present disclosure. Particularly, collection bag 600 is a three-handle bag 602 that facilitates convenient lifting and dumping of clippings from collection bag 600. Three-handle bag 602 includes a bag front handle 616 positioned on a front portion of collection bag 600 (e.g., bag forward portion 518 of FIG. 5, supra) that rests on a mow deck of a disclosed maintenance apparatus (see, e.g., FIGS. 7 and 7A). In an embodiment, bag front handle 616 can be secured to a front or forward surface of the front portion of collection bag 600. A bag top handle 612 is secured to a rear portion of collection bag 600 (e.g., bag rear portion 516 of FIG. 5, supra). As an example, bag top handle 612 can be secured to a top surface of a lid of collection bag 600. A bag mid handle 614 can be secured near an intersection of bag forward portion 518 and bag rear portion 516. The positioning of bag mid handle 614 facilitates provides a lift point near a center of mass of a full collection bag 600 to facilitate easy lifting of collection bag 600 when full. Further, position of bag front handle 616 and bag top handle 612 facilitate easy opening of the top lid and dumping of clippings within collection bag 600. For instance, the top lid can be hinged near the intersection of bag forward portion 518 and bag rear portion 516 so that when lifting a full bag by bag top handle 612 and bag front handle 616, the bottom (rear) portion of collection bag 600 rotates downward and away from bag top handle 612, opening the lid of collection bag 600 and facilitating easy dumping of clippings from collection bag 600 through the window.

FIG. 7 shows an image of a high efficiency mowing apparatus 700 with a collection bag removed. High efficiency mowing apparatus 700 shows a top side of a mow deck 710 (in contrast to mow deck interior 100 of FIG. 1, supra). A rear portion 724 of mow deck 710 is depicted at which a forward portion of a collection bag rests. A rear lift stabilizer 722 is depicted, and the rear portion 724 of the mow deck extends forward of rear lift stabilizer 722. A collection bag resting upon a portion of mow deck 710 can stabilize the weight of high efficiency mower 700 forward of the rear wheels (see FIG. 7A, infra).

High efficiency mowing apparatus 700 includes a discharge chute 714 coupled to a discharge opening in mow deck 710. Additionally, mow deck 710 defines a mow deck perimeter 712, within which discharge chute 714 is confined 718. As is evident from FIG. 7, a forward extent 716 of discharge chute 714 extends to a forward portion of the frame where the frame intersects mow deck 710 at a forward portion of mow deck 710. Likewise, a rear extent of discharge chute 714 can extend to a rear portion of the frame where the frame intersects mow deck 710 at a rear portion of the mow deck 710 (see also FIG. 8, infra).

FIG. 7A illustrates a diagram of a high efficiency mower with collection bag placement 700A, in additional embodiments of the present disclosure. Mow deck 710A is shown with an illustration of a discharge chute opening 712A on a right side of mow deck 710A (relative to an operator's position behind high efficiency mower 700A). A collection bag 720A is illustrated having a forward portion 722A of collection bag 720A that rests on a rear portion of mow deck 710A forward of rear wheels 730. When resting in part on mow deck 710A, collection bag 720A moves a center of gravity of high efficiency mower 700A forward, mitigating or avoiding high efficiency mower 700A from tipping backward over rear wheels 730A. This allows high efficiency mower 700A to be designed as a relatively lightweight machine, enabling low power consumption of various disclosed embodiments. Further, the forward placement of collection bag 720A facilitates a compact design and gives an operator more walking room behind collection bag 720A.

FIG. 8 illustrates a further embodiment of a high efficiency mower 800. High efficiency mower 800 is depicted absent the collection bag and absent the discharge chute. High efficiency mower 800 is depicted with a mow deck 810 and discharge chute opening 820 within mow deck 810. A mulching cover 830 is depicted to close discharge chute opening 820 when the discharge chute is removed. This allows the high efficiency mower 800 to be operated in a mulching mode when the collection bag and discharge chute are removed, with mulching cover 830 closing off discharge chute opening 820. In the embodiment depicted by FIG. 8, discharge chute opening 820 extends at a forward portion to a forward intersection of a frame rail 815 of high efficiency mower 800 with the mow deck (or substantially to, e.g., an inch or less away from the intersection), and at a rear portion to a rear intersection of the frame with the mow deck (or substantially to, e.g., an inch or less away from the intersection).

In alternative or additional embodiments, discharge chute opening 820 can be defined in part with respect to a secant line that intersects a perimeter of mow deck 810 at two points. The perimeter can be a perimeter of a top surface of mow deck 810 in an embodiment, or an outermost perimeter of mow deck 810 in other embodiments (or suitable perimeter defined there between), depending on implementation and on how discharge chute opening 820 is formed within mow deck 810. In at least one aspect of these embodiments, the secant line can also cross a wheel axis of at least one of: a front wheel or a rear wheel of high efficiency mower 800. Secant line 840 illustrated in FIG. 8 is such a secant line that intersects a perimeter of mow deck 810 at two points, and also intersects a wheel axis of at least a front wheel or a rear wheel (both the front wheel axis and rear wheel axis in the example depicted by FIG. 8). In such embodiments, discharge chute opening 820 intersects or crosses secant line 840 at a rear portion 832 of discharge chute opening 820 and at a front portion 834 of discharge chute opening. In an embodiment, both the rear portion 832 and the front portion 834 can be points on a single curve portion 840 of discharge chute opening 820.

The size and extent of discharge chute opening 820 helps facilitate a flow of clippings rearward along a discharge chute to a rear of a collection bag. By directing clipping flow in a rearward direction toward a rear of a collection bag, the collection bag can fill from a rear portion of the collection bag first toward a front portion of the collection bag. This helps prevent clogging of the discharge chute before the collection bag is full.

FIG. 8A illustrates a high efficiency mower 800A according to further embodiments of the present disclosure. High efficiency mower 800A illustrates a side-forward discharge chute opening 812A within a mow deck 810A of high efficiency mower 800A. For a direction of blade rotation 814A as illustrated (clockwise direction looking downward from above high efficiency mower 800A), clippings flowing into side-forward discharge chute opening 812A have a direction of motion approximately tangential to direction of blade motion 814A, resulting in an approximately rearward basic clipping flow direction 816A as illustrated by the green arrows. This facilitates filling of collection bag 820A from a rear of collection bag 820A to a front of collection bag 820A, mitigating or avoiding clogging of a discharge chute prior to filling collection bag 820A.

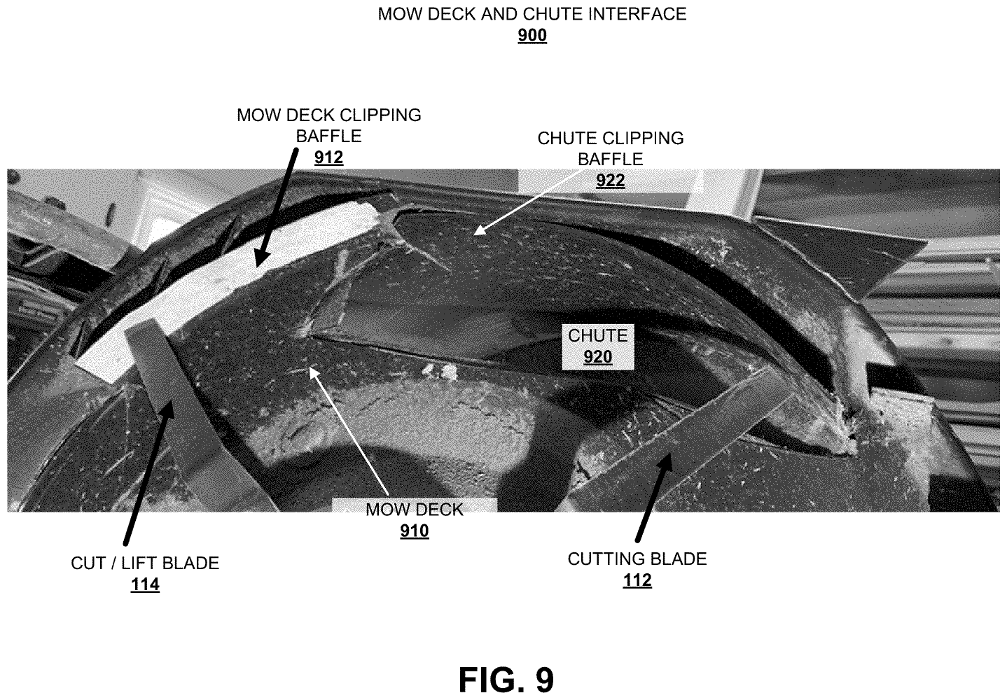

FIG. 9 depicts a diagram of a mow deck and chute interface 900 within an interior of a mow deck 910 for a lawn maintenance apparatus, according to further embodiments of the present disclosure. FIG. 9 depicts a mow deck clipping baffle 912 to guide clippings within mow deck 910 toward a discharge chute opening of mow deck 910, and within (as opposed, e.g., behind) a chute clipping baffle 922 of a discharge chute 920. Cut/lift blade 114 generates lift for clippings within mow deck 910 that brings the clippings upward toward a surface of mow deck 910. The lift also effectively pushes clippings that reach the discharge chute opening up into chute 920 where they can be guided by chute 920 out of mow deck 910.

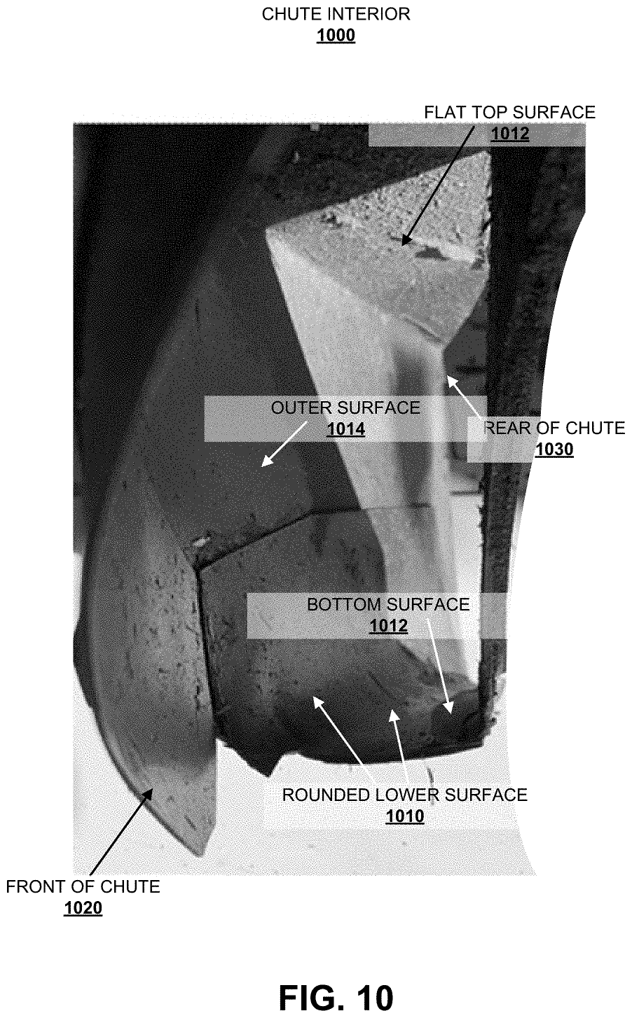

As illustrated by FIG. 10, chute interior 1000 is designed to receive clippings from the discharge chute opening. For instance, a front of chute 1020 surface can be designed to fit conformally inside a discharge chute opening of a mow deck. Further, a bottom of chute interior 1000 near a rear portion of a mow deck and discharge chute opening can have a rounded lower surface 1010. The rounded lower surface can provide a non-square interface (e.g., a curvature at the interface) between a bottom surface 1012 of chute interior 1000 and an outer surface 1014 of chute interior 1000. The rounded lower surface 1010 provides lift to clippings flowing from front of chute 1020 to rear of chute 1030. This lift within chute interior 1000 facilitates flow and projection of clippings to a rear of a collection bag, and mitigates or avoids clumping or clogging at a chute/collection bag interface.

The rounded lower surface 1010 can have a circular curvature in an embodiment, an approximately circular curvature, an elliptical curvature or approximately elliptical curvature, a parabolic curvature or approximately parabolic curvature, or other suitable curvature known in the art or reasonably conveyed to one of skill in the art by way of the context provided herein. As utilized for rounded lower surface 1010, approximately (or like relative terms such as about, roughly and so forth) refers in some embodiments to a curvature that is not a precise mathematical circle, ellipse, parabola, or other suitable mathematically defined curvature. In additional embodiments, approximately refers to ranges of manufacturing tolerances associated with suitable manufacturing equipment (e.g., injection molding equipment, extrusion equipment, metal stamping equipment, and so forth) for realizing a curved surface from a mathematical curved design. In some embodiments, approximately can refer to a 0 to 5-degree variance or a zero to ten-degree variance from precise mathematically defined curvatures, or any suitable value or range there between. In at least one embodiment, rounded lower surface 1010 can have a radius of curvature in a range of about 0.75 to about 1.50 inches, or any suitable value or range there between. In an embodiment, rounded lower surface 1010 can have a radius of curvature of 1.0 inch or about 1.0 inch; in another embodiment, rounded lower surface 1010 can have a radius of curvature of 1.25 inches or about 1.25 inches.

In addition to the forgoing, chute interior 1000 can have a flat top surface 1012. Flat top surface 1012 can have a right angle or approximately right angle (e.g., within 0 to 5-degrees or 0 to 10-degrees, or any suitable value or range there between) to outer surface 1014. Flat top surface 1012 can facilitate retaining flow of clippings that reaches the top surface at or near flat top surface 1012. This can also facilitate projecting the clippings toward a rear of a collection bag, mitigating or avoiding clumping or clogging of a chute/collection bag interface. In conjunction with rounded lower surface 1010 chute interior is designed to further lift clippings upward within chute interior and maintain height within chute interior 1000 as they flow from front of chute 1020 to rear of chute 1030. Accordingly, chute interior 1000 is configured to avoid clumping or clogging of a chute/collection bag interface before the collection bag is filled, improved efficiency and effectiveness of disclosed bagging systems.

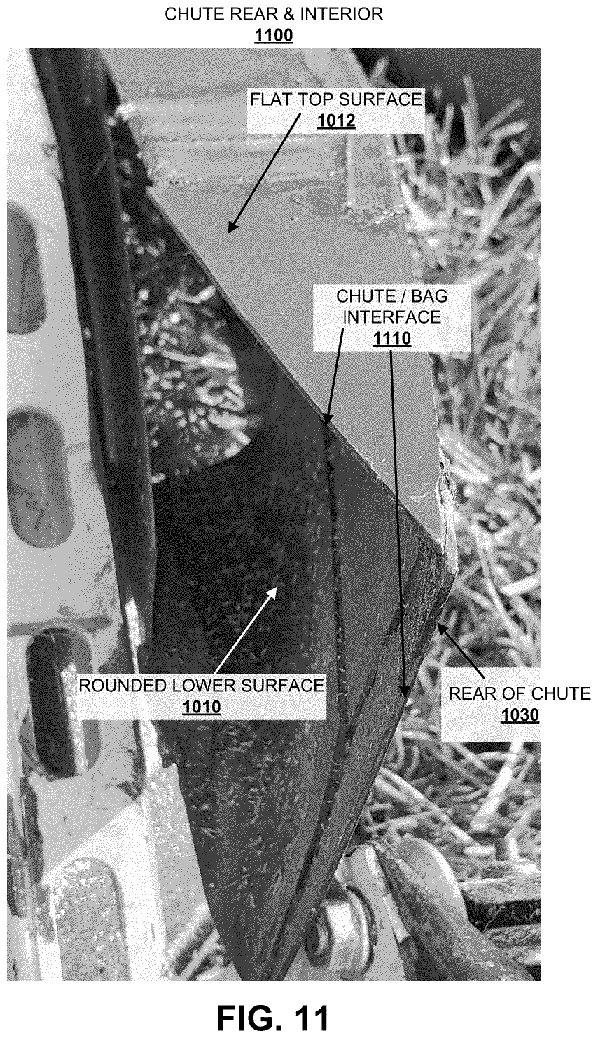

FIG. 11 illustrates an image of an example chute rear and interior 1100 according to alternative or additional embodiments of the present disclosure. As described above at FIG. 10, rounded lower surface 1010 and flat top surface 1012 are configured to lift clippings upward within the interior of the chute and maintain clippings at flat top surface 1012. Clippings having higher loft within the chute interior are more likely to be projected further beyond rear of chute 1030, minimizing or avoiding clogging the chute/bag interface 1110 before the collection bag is full.

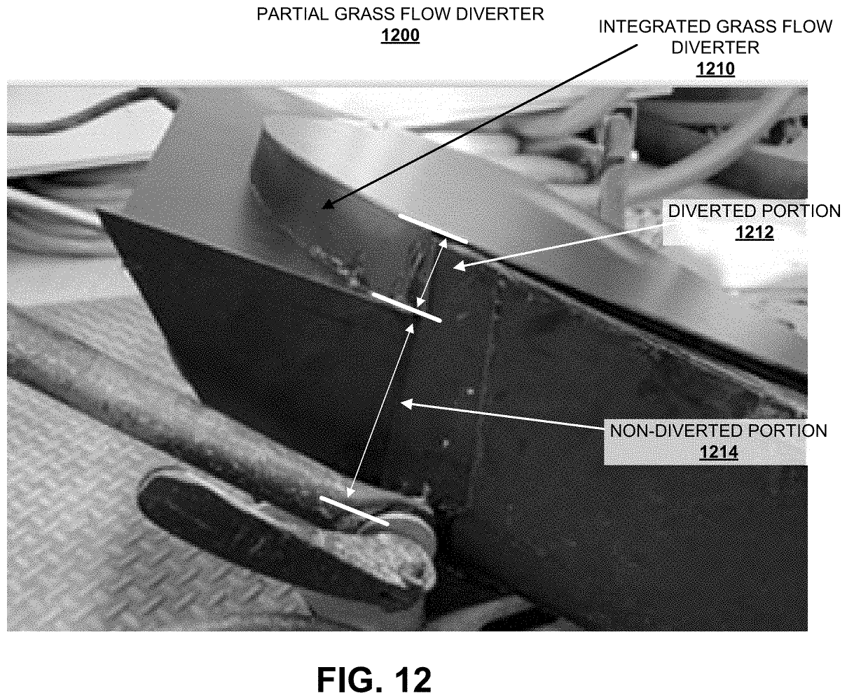

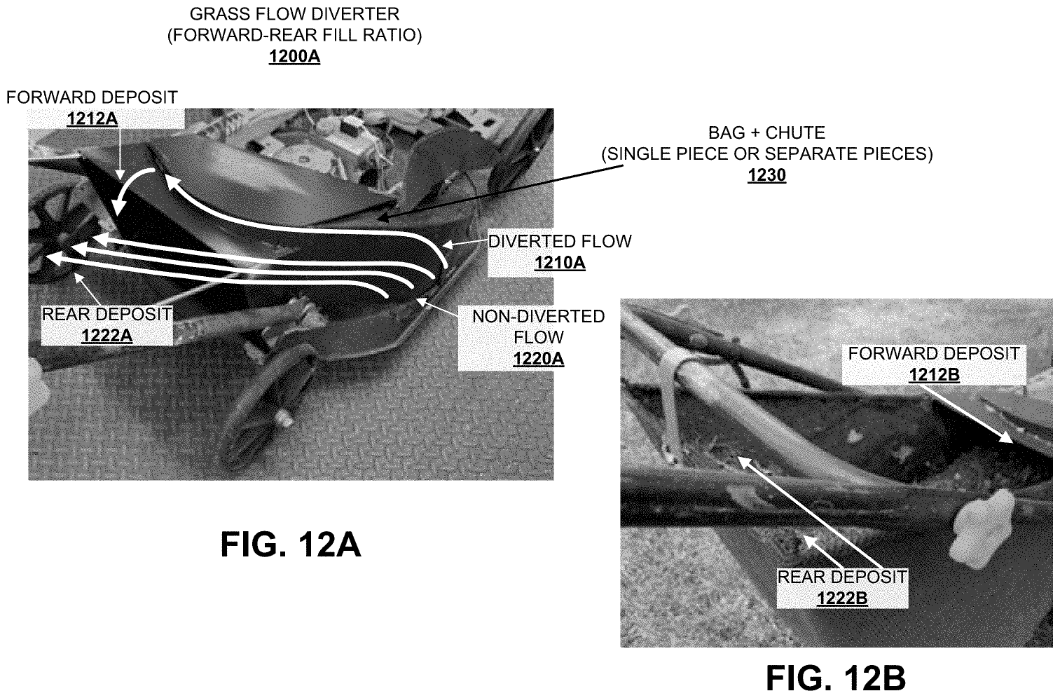

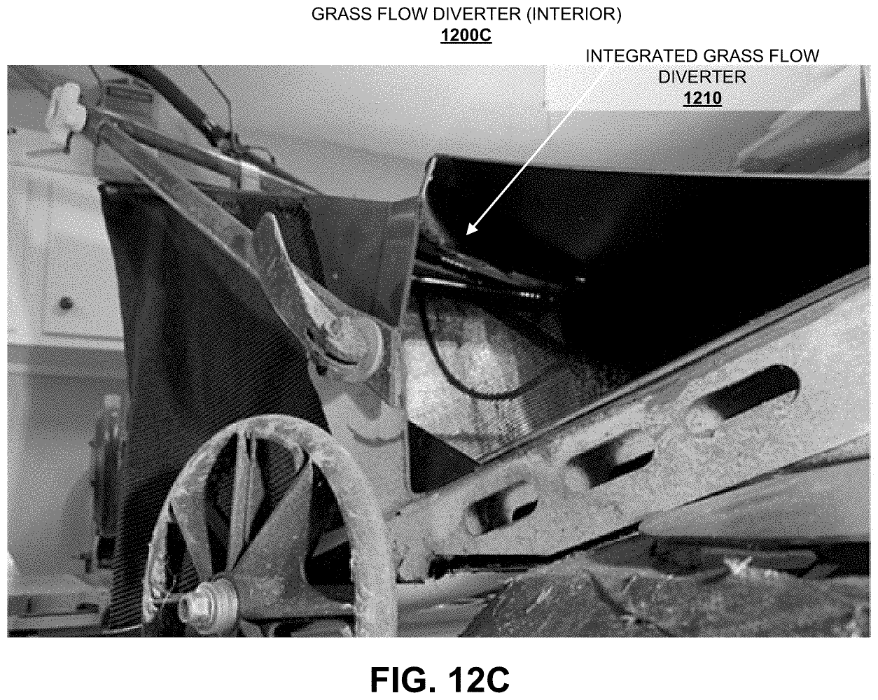

FIG. 12 illustrates a partial grass flow diverter 1200 for a disclosed bagging system of a lawn maintenance apparatus according to still additional embodiments of the present disclosure. Partial grass flow diverter 1200 can be positioned near an interface of a discharge chute and a collection bag, as disclosed herein. In one embodiment, an integrated grass flow diverter 1210 can be formed as an integral part of a front portion of a collection bag (e.g., see FIG. 12B, infra). In another embodiment, integrated grass flow diverter 1210 can be formed as an integral part of a rear of a discharge chute at the interface of the discharge chute and the collection bag. In yet another embodiment, where the discharge chute and collection bag are formed as a single physical device, integrated grass flow diverter 1210 can be formed as a contiguous portion between the discharge chute and collection bag, exclusively within the front portion of the collection bag or exclusively within a rare portion of the discharge chute, according to design preference.

In the embodiment depicted by FIG. 12, integrated grass flow diverter 1210 is formed as part of a front portion of a collection bag, and defines a diverted portion 1212 of the front portion of the collection bag and a non-diverted portion 1214 of the front portion of the collection bag. Integrated grass flow diverter 1210 is configured to direct clippings engaging with diverted portion 1212 of the front portion of the collection bag to an opposite side of the front portion of the collection bag from the chute/bag interface (see FIG. 12B, infra). Diverting clippings to the front-opposite side of the collection bag can help fill the collection bag fully, and can help balance weight of the collection bag as it fills between the front and rear portions of the collection bag. With the front portion of the collection bag resting on a rear portion of the mow deck to balance overall weight of the lawn maintenance apparatus, filling the bag from the front and rear concurrently can facilitate a favorable weight balance of the collection bag. The height of diverted portion 1212 relative to non-diverted portion 1214 controls the amount of turf clippings redirected to the front-opposite side of the collection bag as opposed to the rear of the collection bag (see FIG. 12A, infra). Accordingly, a ratio of the diverted portion 1212 to the non-diverted portion 1214 can be selected based on design preference, in various embodiments, to configure the relative fill rate of the front-opposite corner of the collection bag and the rear portion of the collection bag.

FIG. 12A illustrates a diagram of a grass flow diverter 1200A according to alternative or additional embodiments of the present disclosure. Grass flow diverter 1200A can be configured to divert a portion of turf clippings directed by a discharge chute toward a rear portion of a collection bag of a bagging assembly, to a front portion of the collection bag. Particularly, grass flow diverter 1200A can be configured to divert the portion of turf clippings to the front portion of the collection bag on an opposite side from an opening (e.g., an output) of the discharge chute.

As illustrated by the white arrows of FIG. 12A, grass flow diverter 1200A causes a diverted flow 1210A of turf clippings to be deposited at a forward deposit 1212A position of a bagging assembly. As illustrated, forward deposition 1212A position can be at an opposite side of the front portion of the bagging assembly from an output of the discharge chute. As illustrated in FIG. 12B, the forward deposit 1212B of turf clippings can fill from the opposite front portion of the bagging assembly toward the center of the front portion and the center of the bagging assembly, and finally fill toward the output of the discharge chute once the bagging assembly becomes full.

Non-diverted flow 1220A of turf clippings follow a path defined by the white arrows associated with non-diverted flow 1220A. As described above, non-diverted flow 1220A directs turf clippings toward a rear of the collection bag, and fills the collection bag from the rear toward the front. Rear deposit 1222B of FIG. 12B depicts where turf clippings of non-diverted flow 1220A will begin to aggregate.

In various embodiments, forward deposit 1212B can help to balance weight distribution of turf clippings within the collection bag while the bag is being filled. In various embodiments of the present disclosure, a front portion of the collection bag rests on the mow deck. To minimize power consumption of a high efficiency lawn maintenance device, and therefore improve battery life and overall performance, reducing overall weight of the lawn maintenance device is preferred. This weight reduction, however, may lead to weight distribution challenges when the collection bag becomes filled, in at least some embodiments. For instance, where the lawn maintenance device has relatively small weight at the mow deck, collection of turf clippings in the rear of the collection bag can cause the lawn maintenance device to become unbalanced toward the rear of the collection bag. If uncorrected, the weight unbalance can lead to problems such as rearward tipping over the rear wheels, or the like. By distributing turf clippings to the front of the collection bag, particularly in embodiments where the front portion rests upon the mow deck, diverted flow 1210A of turf clippings can balance turf clipping weight within the collection bag and can also balance overall forward-rearward weight balance of the lawn maintenance machine when utilizing a bagging assembly. In addition to the foregoing, positioning the front portion of the collection bag on the rear of the mow deck moves the bagging assembly further forward compared with conventional bagging systems. This has the additional benefit of reducing the distance from the discharge opening of the mow deck to the entrance (and to the rear) of the collection bag. This reduced distance in turn reduces the power required to effectively throw turf clippings into the bag, and to fill the bag from the rear of the collection bag to the front the front of the collection bag. This further reduces the likelihood of clogging the chute/bag interface by ensuring turf clippings have the momentum to reach the rear of the collection bag.

In addition to the foregoing, diverted flow 1210A can facilitate the complete filling of the collection bag when in use. For instance, with all turf clippings following non-diverted flow 1220A, the collection bag may fill from the rear of the collection bag to the front of the collection bag. Depending on geometry of the collection bag, this rear to front filling can leave a small portion of the front portion of the collection bag (near forward deposit 1212B opposite the output of the discharge chute) partially unfilled. As a result, the collection bag may not be completely filled before the discharge chute output becomes clogged, and therefore the capacity of the collection bag may not be fully realized. By diverting a portion of turf clippings to forward deposit 1212B, the collection bag can be filled more completely before the collection bag needs to be emptied, maximizing efficiency of the bagging assembly system, according to various disclosed embodiments.

Referring to FIG. 12C, an alternative view 1200C of the grass flow diverter 1200 of FIG. 12 is provided. Integrated grass flow diverter 1210 is illustrated from an interior perspective when looking through the output of the discharge chute. As described above, turf clippings mechanically interacting with integrated grass flow diverter 1210 are redirected to a front portion of the collection bag, opposite the output of the discharge chute, instead of continuing on toward the rear of the collection bag. Adjusting the height of integrated grass flow diverter 1210 (e.g., at manufacture, or by way of an adjustable mechanism for user adjustment post-manufacture—not depicted) facilitates design choice (or user choice) in determining the amount of turf clippings redirected away from the rear portion of the collection bag. This can facilitate optimization of weight distribution of the collection bag, fully realizing the collection capacity of the collection bag, or like benefits.

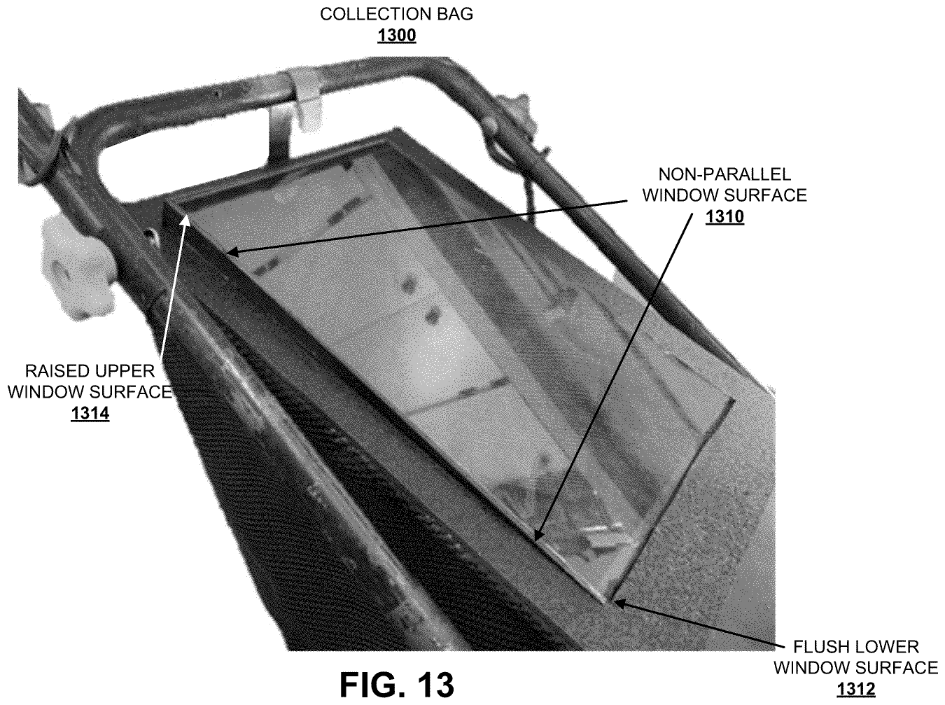

FIG. 13 illustrates a collection bag 1300 for a high efficiency lawn mower bagging assembly according to alternative or additional embodiments of the present disclosure. For instance, collection bag 1300 of FIG. 13 illustrates a non-parallel window surface 1310 that is non-flush with a top surface of collection bag 1300 at least for a portion of the non-parallel window surface 1310. As one example, non-parallel window surface 1310 can include a flush lower window surface 1312 and a raised upper window surface 1314. In the illustrated embodiment, positioning non-parallel window surface 1310 as non-flush with at least a portion of the top surface of collection bag 1300 can reduce the amount of turf clippings that stick to the non-parallel window surface 1310 in operation. The non-flush surface can therefore enhance the viewability of the interior of the collection bag while in operation.

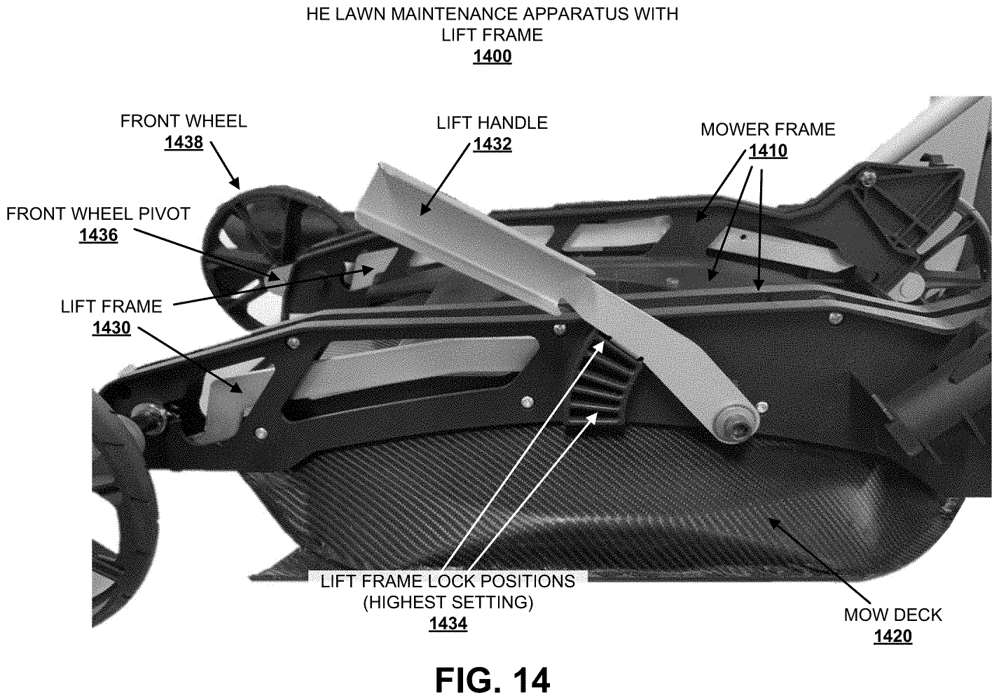

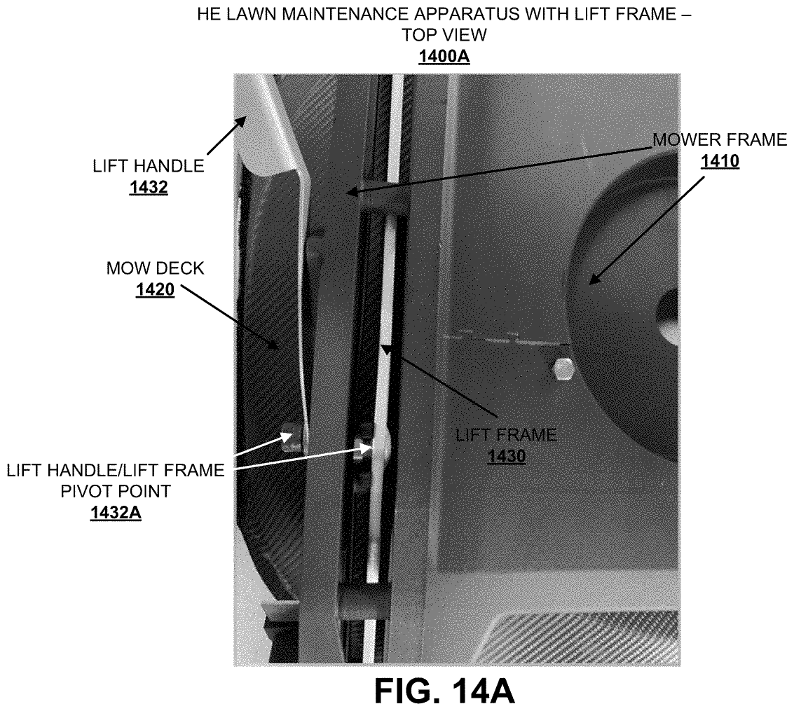

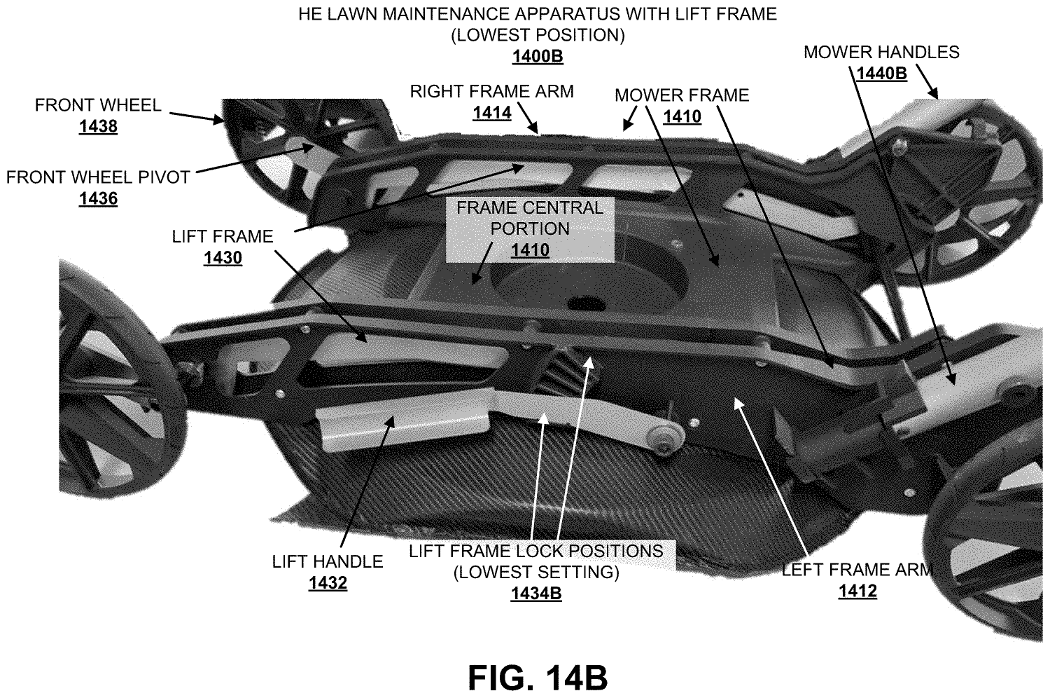

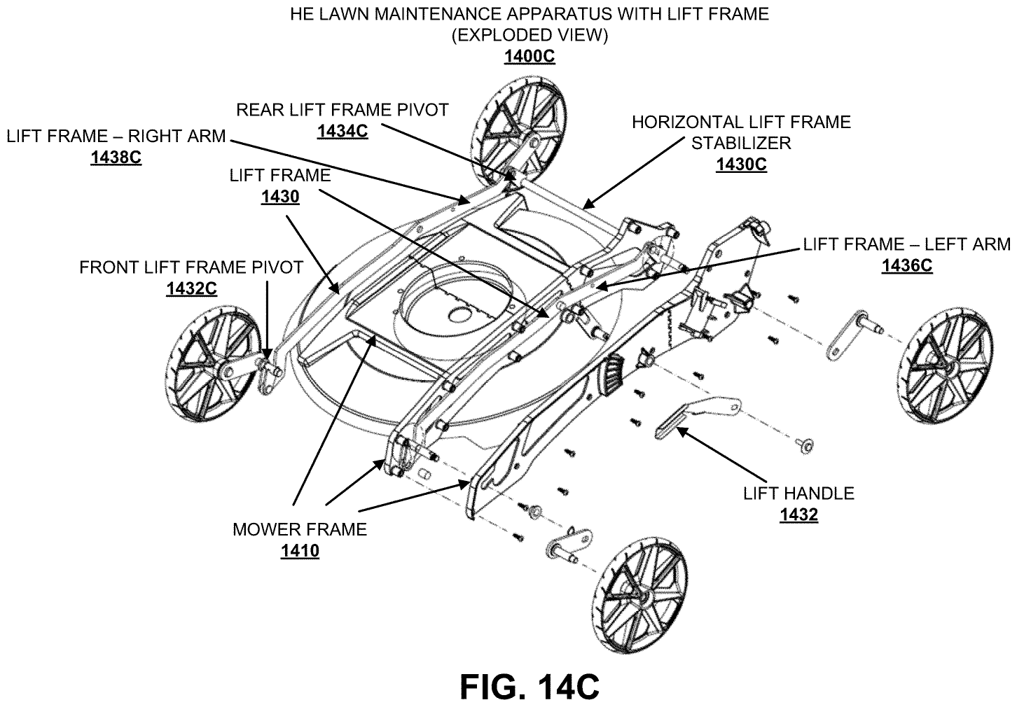

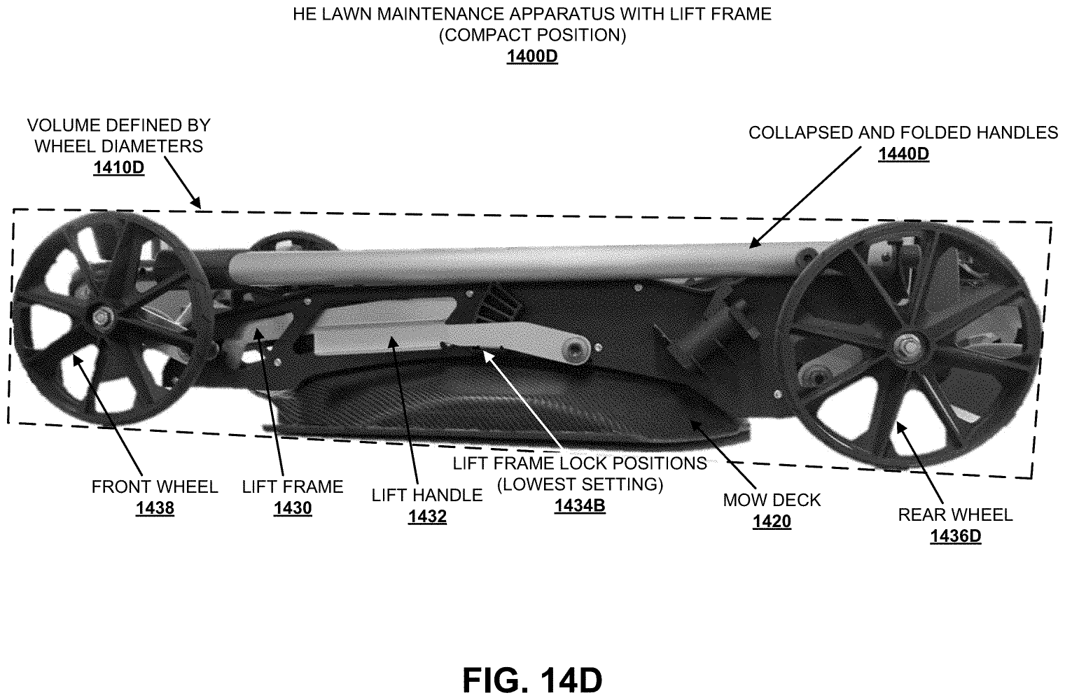

FIGS. 14-14D illustrate example embodiments of a lift frame 1430 for a high efficiency (HE) lawn maintenance apparatus according to still further embodiments of the present disclosure. As depicted by FIG. 14, HE lawn maintenance apparatus 1400 includes a mower frame 1410 secured to a mow deck 1420, front wheels 1438 and rear wheels (not depicted, but see FIG. 14D, infra) of the HE lawn maintenance apparatus. Secured to mower frame 1410 is a lift frame 1430 configured to raise or lower mow deck 1420 relative to front wheels 1438 and the rear wheels. In an embodiment, mower frame 1410 can also be partially or wholly raised or lowered relative to front wheels 1438 and the rear wheels, depending on various embodiments. For instance, lift frame 1430 can rotate about front wheel pivot 1436 to raise or lower mow deck 1420 (alone or in combination with mower frame 1410) according to one or more embodiments. A lift handle 1432 can be adjusted to effect the raising/lowering of the lift frame 1430. Lift frame lock positions at a highest setting 1434 raise mow deck 1420 to its highest position, and moving the lift handle 1432 to other (lower) positions of the lift frame lock positions enable lowering the mow deck 1420.

FIG. 14A depicts a top view 1400A of the lift frame 1430 of the HE lawn maintenance apparatus 1400, according to further embodiments. As illustrated by top view 1400A, the embodiment illustrated by FIG. 14A includes a gap within mower frame 1410 in which a left-side arm of lift frame 1430 is situated. A lift handle/lift frame pivot point 1432A connects lift handle 1432 to the left-side arm of lift frame 1430. Torque applied to lift handle 1432 is transferred to lift frame 1430 by way of lift handle/lift frame pivot point 1432A. Torque transferred to the left-side of lift frame 1430 can effectuate the raising and lowering of lift frame 1430 and mow deck 1420.

FIG. 14B depicts a view of HE lawn maintenance apparatus 1400 in a lowest position. Specifically, lift handle 1432 is in a lowest setting 1434B of lift frame lock positions 1434. As a result, lift frame 1430 rotates about front wheel pivot 1436 in a lowest position to lower mow deck 1420 to a lowest position. While in the lowest position, mower handles 1440B can be extended to push and operate the HE lawn maintenance apparatus 1400 in the lowest position.

FIG. 14C depicts an exploded view 1400C of the mower frame 1410 and lift frame 1430 of a HE lawn maintenance apparatus 1400C, according to still further embodiments of the present disclosure. The gap within mower frame 1410 in which a left arm 1436C of lift frame 1430 is situated—as illustrated in top view 1400A of FIG. 14A—can be seen by exploded view 1400C. Exploded view 1400C depicts an embodiment where lift handle 1432 connects to left arm 1436C by way of the lift handle/lift frame pivot point 1432A of FIG. 14A. As described with respect to FIG. 14A, torque applied to lift handle 1432 is transferred to left arm 1436C as lift handle 1432 is moved between lowest setting 1434B of lift frame lock positions 1434 and the highest setting of lift frame lock positions 1434 (see FIG. 14). A rear portion of left arm 1436C of lift frame 1430 is physically connected to a horizontal lift frame stabilizer 1430C. Horizontal lift frame stabilizer 1430C applies torque from left arm 1436C to a right arm 1438C of lift frame 1430 on a right side (when viewed from behind HE lawn maintenance apparatus 1400C) of lift frame 1430. By way of lift frame stabilizer 1430C then, torque applied to lift handle 1432 can be applied to all of lift frame 1430 (including left arm 1436C and right arm 1438C), to raise or lower lift frame 1430 (and mower frame 1410 and mow deck 1420 in various embodiments) as a contiguous unit by way of a single lift handle 1432. In an embodiment, torque applied to left arm 1436C and right arm 1438C causes lift frame 1430 to rotate about front lift frame pivot 1432C and rear lift frame pivot 1434C, thereby raising/lowering lift frame 1430 (and mower frame 1410 and mow deck 1420).

In various embodiments, lift frame 1430 provides an advantage over conventional walk-behind lawn maintenance devices that require each wheel to be raised/lowered to raise or lower a mow deck, or that requires the front (wheels) to be raised/lowered separate from the rear (wheels) or the left side (wheels) to be raised/lowered separate from the right side (wheels). Lift frame 1430 therefore provides an efficient and effective height adjustment for a mow deck 1420 of a HE lawn maintenance apparatus according to various disclosed embodiments.

FIG. 14D illustrates a compact position 1400D for a HE lawn maintenance apparatus 1400 according to still further embodiments of the present disclosure. In various embodiments, HE lawn maintenance apparatus 1400 can be mechanically positioned into compact position 1400D in which HE lawn maintenance apparatus 1400 is contained within a volume defined by the wheels of the HE lawn maintenance apparatus 1400. With different words, a volume defined by wheel diameters 1410D can include a perimeter in two dimensions defined by the outer diameter of front wheel 1438 and rear wheel 1436D (dashed rectangle illustrated in FIG. 14D) extended into a third dimension to encompass the diameters of the other two wheels (the dashed rectangle extended into the page to bound the other two wheels and define a volume).

HE lawn maintenance apparatus 1400 can be positioned into compact position 1400D by lowering lift frame handle 1432 to lowest setting 1434B of lift frame lock positions 1434, as illustrated in FIG. 14D. This places lift frame 1430 and mow deck 1420 in a lowest position still within the volume defined by wheel diameters 1410D. Subsequently, mower handles 1440B (shown extended in FIG. 14B, supra) can be compressed, collapsed, folded, rotated or the like or a suitable combination of the foregoing (e.g., collapsed and folded/rotated) into a collapsed and folded position. One example (though not limiting) is illustrated by collapsed and folded handles 1440D of FIG. 14D. With lift handle 1432 in lowest setting 1434B and mower handles 1440B in position illustrated by collapsed and folded handles 1440D, HE lawn maintenance apparatus 1400 is in compact position 1400D. As a result, HE lawn maintenance apparatus 1400 is fully contained within volume defined by wheel diameters 1410D (of the front wheels 1438 and rear wheels 1436D). This allows HE lawn maintenance apparatus 1400 to be stored efficiently and compactly, or to be shipped within a rectangular package accommodating volume defined by wheel diameters 1410D, or the like.

In one or more additional embodiments, HE lawn maintenance apparatus 1400 can be configured with interchangeable mow decks, and mow deck sizes. Referring to FIG. 14B, different size mow decks 1420 could be connected to mower frame 1410 by suitable fastening devices. Interchangeability of mow deck size can allow for multiple models to be assembled yielding devices with different sized radii of cut and associated parameters. For example, a manufacturer could assemble disclosed HE lawn maintenance apparatus 1400 to different sized mow decks, with single blade models, multiple blade models and so forth according to this embodiment. In various embodiments, and by way of non-limiting example, 17″ to 22″ mow deck sizes—having respective cutting diameters suitable to the respective mow deck sizes—could be interchanged on HE lawn maintenance apparatus 1400, though larger or smaller diameter mow decks (and cutting diameters) are within the scope of the present disclosure (e.g., deck sizes and cutting diameters from 15 to 60 inches could be implemented in various embodiments). In a further embodiment, mower frame 1410 can be adjustable in width to accommodate different diameter mow deck sizes. In such embodiment, mower frame 1410 could be collapsible in a width direction (e.g., from left side to right side, viewed from an operator's position behind HE lawn maintenance apparatus 1400) to maintain a desired frame width to mow deck diameter. As an example illustration, mower frame 1410 could comprise a central portion including inter-connected telescoping tubes of different diameter with an inner tube(s) that can be adjusted further inward of an outer tube(s) (to reduce mower frame width) or adjusted further outward of the outer tube(s) (to increase mower frame width). Width can be expanded/contracted with two or more telescoping inner/outer diameter tubes, or in another embodiment the frame can be modular with left-right frame arms 1412, 1414 that secure to different sized central portions 1410—resulting in different widths between the left-right frame arms 1412, 1414—to expand/contract the width of the mow deck. Similarly, horizontal stabilizer 1430C can likewise shorten and lengthen with the width of mower frame 1410.

In still further embodiments, front wheels 1438 or rear wheels (or both) can be configured to adjust along a length of lift frame—right arm 1438C and lift frame—left arm 1436C to provide an adjustable wheel base. As one example, front lift frame pivot 1432C, front wheels 1438 and associated connectors can be moved to additional holes (not depicted) along the length of respective front portions of the left and right lift frame arms to move the front wheels 1438 backward along the frame arms or forward along the frame arms 1436C, 1438C, to adjust the forward wheel base. Alternatively the left and right frame arms 1436C, 1438C can have interior cutouts, grooves, notches, or the like along which front wheels 1438 or the rear wheels (or both) can be moved to adjust the forward or rear wheel bases, respectively, depending on implementation. Based on these embodiments, lift frame 1430 as well as the forward or rear wheel base dimensions can be adjusted to accommodate differing mow deck sizes based on operator preference.

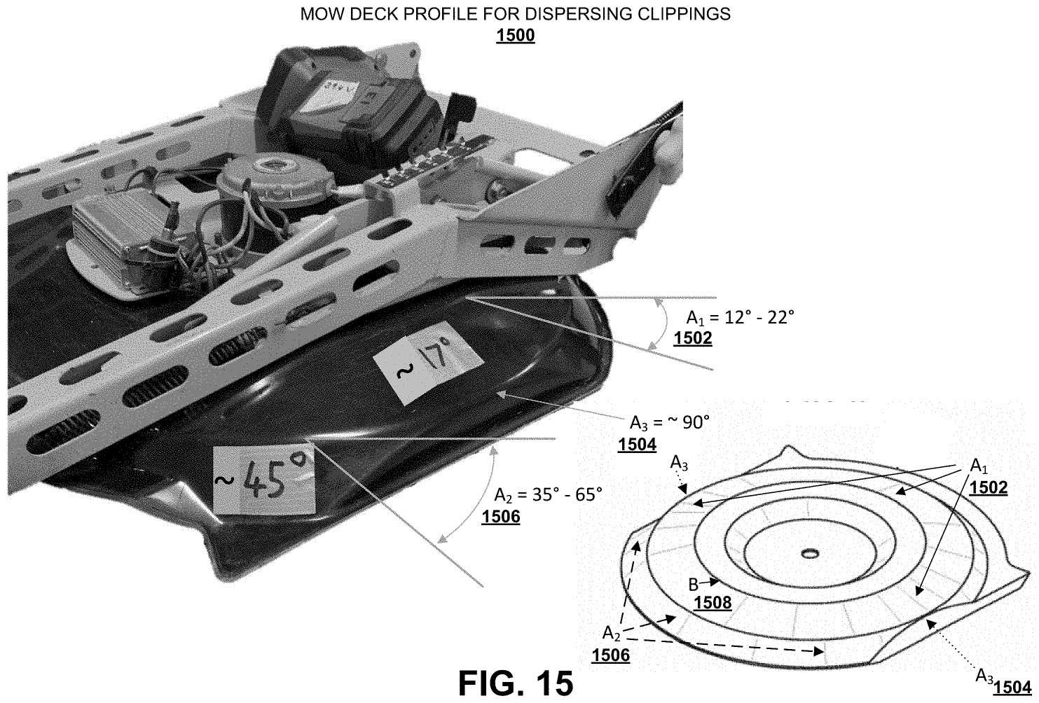

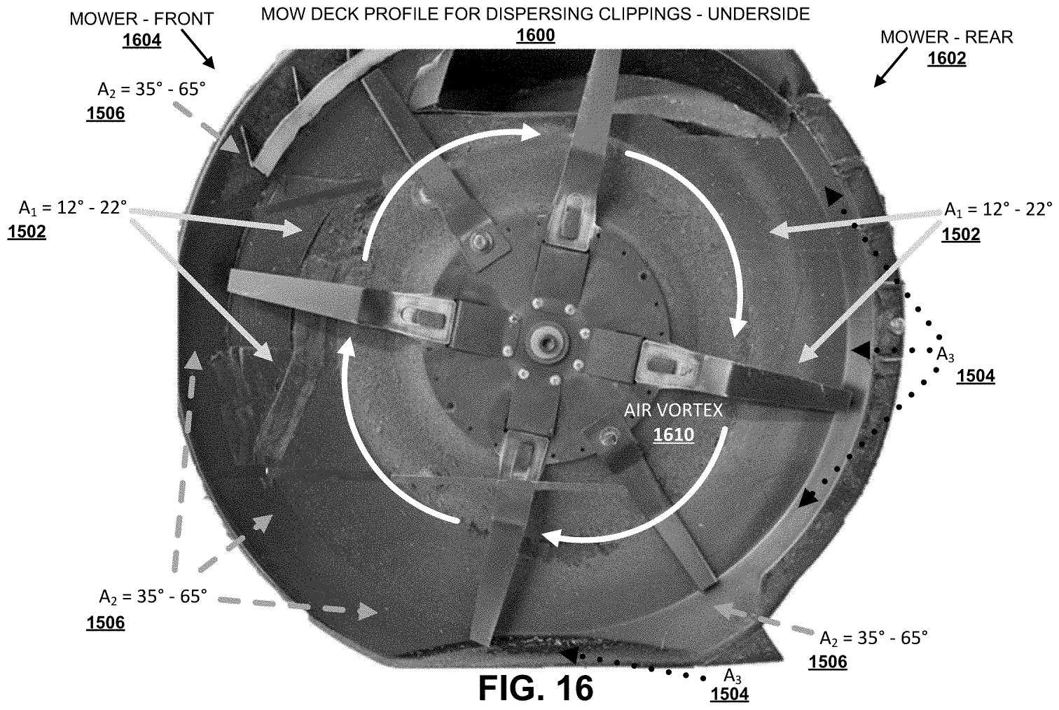

FIG. 15 illustrates an example mow deck 1500 configured for efficient ejection of clippings from an interior of the mow deck according to alternative or additional embodiments of the present disclosure. FIG. 15 provides a picture of an example high efficiency lawn mowing machine with a cutout illustration of an example implementation of the mow deck in the lower right corner of the illustration. Mow deck 1500 is configured to rapidly disperse and eject clippings from an interior of mow deck 1500 to an exterior thereof and to the ground beneath mow deck 1500. Rapid dispersal and ejection of clippings out from the interior of mow deck 1500 serves to remove mass (e.g., grass or turf clippings, dirt, and so forth) from an air vortex caused by rotation of cutting blades of mow deck 1500 (e.g., see FIG. 16, infra, as well as blade assembly 130 of FIG. 1, supra). The reduced mass can serve to reduce effective viscosity of the air vortex and therefore reduce power consumption of a motor driving the cutting blades. Reducing power consumption can enhance longevity of batteries powering the motor, reduce fuel consumption, and so forth.

Conventional mow decks generally cover the mowing blades and protect objects and persons from damage by unintended contact with the rotating blades. A common mow deck interior will have a perimeter bounded by a ninety degree or substantially ninety degree surface or wall. This wall protects objects external to the mow deck from coming in contact with the rotating blades, but also tends to retain turf clippings, dirt, and other material within an air vortex caused by the rotating blades, rather than ejecting the mass there from. This produces a mulching effect, resulting from the blades striking the material multiple times within the air vortex to chop the material into finer structure. However, mulching material into finer structure adds more resistance to the rotating blades and consumes more power, reducing the power efficiency of the conventional mow deck. Mow deck 1500 enhances efficiency and reduces power consumption by having an interior mow deck shape that promotes ejection of matter from the air vortex, minimizing mulching and reducing resistance to the rotating blades.

Mow deck 1500 can have a first portion having an angle A₁ 1502 configured to permit clippings within an underside of mow deck 1500 to travel to a perimeter and downward from a top surface of a central portion of the underside of mow deck 1500. This travel of clippings toward the perimeter is facilitated by centrifugal forces of the rotating blades. The first portion can have an angle A₁ 1502 with respect to a horizontal plane (e.g., a plane tangential to a peak portion B 1508 of the upper surface of mow deck 1500) in a range from about 12 degrees to about 22 degrees. In a particular example, the angle can be about 17 degrees, including: 15, 16, 17, 18 or 19 degrees, or any suitable range or value therein. The first portion having the angle A₁ 1502 can be between an interior of mow deck 1500 and a perimeter thereof.

In addition, a second portion of mow deck 1500 can have an angle A₂ 1506 that is in a range from about 35 degrees to about 65 degrees from horizontal (direction of the plane tangential to peak portion B 1508). In at least one embodiment, the angle A₂ 1506 can be about forty-five degrees (e.g., in a range from about forty degrees to about fifty degrees, 41, 42, 43, 44, 45, 46, 47, 48, 49, 50 degrees or any suitable value or range there between). The second portion can be near a perimeter of mow deck 1500 and the angle A₂ 1506 can direct clippings toward the ground underneath mow deck 1500. A third portion having an angle A₃ can be at an outer edge of mow deck 1500, and can have an angle of about ninety degrees (e.g., a range from about eighty to about one hundred degrees, or any suitable value or range there between) from the horizontal plane. The third portion is intended to prevent further outward motion of clippings, and to shield the blade from external objects. In an embodiment, cutting blades within an interior of mow deck 1500 can be bounded by and contained within portion 2 and portion 3 of mow deck 1500. In another embodiment, a height or thickness of mow deck measured from a bottom-most edge of mow deck 1500 when in a mowing orientation to a peak portion B 1508 of the upper surface of mow deck 1500 can be in a range of about 2 to about 3 inches. In various embodiments, the height or thickness can be selected from a group measured in inches consisting of: 2, 2.1, 2.2, 2.3, 2.4, 2.5, 2.6, 2.7, 2.8, 2.9 and 3 inches.

FIG. 16 illustrates an interior portion 1600 of mow deck 1500 if FIG. 15. In an embodiment, a front portion of mow deck 1500 (as mounted on a frame; see mower frame 1410 of FIG. 14, supra) can be indicated by mower—front 1604, and a rear portion of mow deck 1500 can be indicated by mower—rear 1602. First, second and third surface portions of mower deck 1500 indicated by angle A₁ 1502, angle A₂ 1506 and angle A₃ 1504 are shown by solid, dashed and dotted lines, respectively. Mower-front 1604 can have first and second portions exclusively, in an embodiment. Side walls of mow deck 1500 can include second and third portions, and mower—rear 1602 can also include second and third portions, as shown. Air vortex 1610 is illustrated by white arrows indicating a direction of air flow within mow deck 1500 in response to rotation of mower blades.

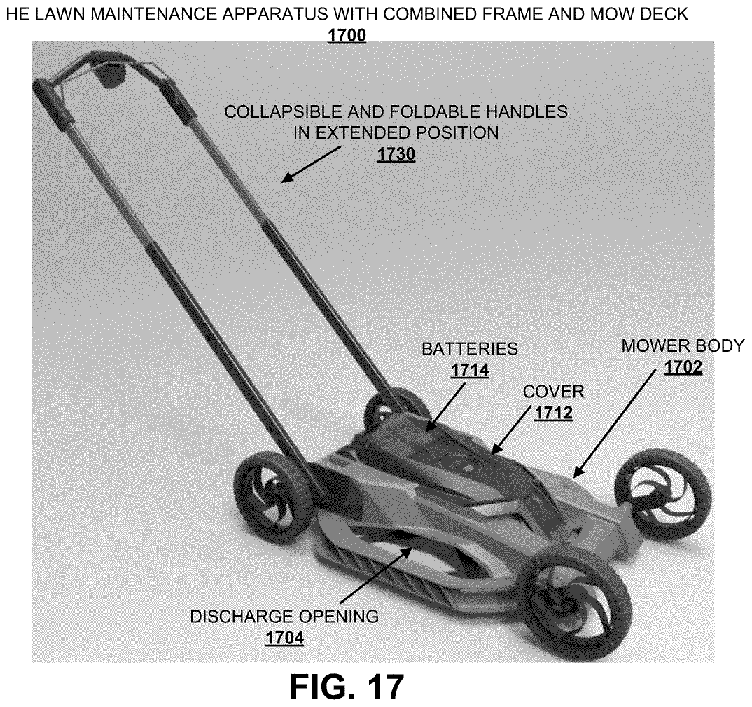

FIG. 17 illustrates a high efficiency lawn maintenance apparatus 1700 with combined mower deck and structural support (e.g., frame). To further illustrate, in comparison with FIG. 14, supra, HE lawn maintenance apparatus 1700 can have an integrated or combined mower body 1702 including a mow deck portion and structural support, as an alternative to a composite apparatus of FIG. 14 in which the mow deck 1420 is a separate piece secured to mower frame 1410. A discharge opening 1704 is defined in the mower body 1702 that can be connected to a discharge chute and bag portion, as described herein, to collect turf clippings and other debris ejected by lawn maintenance apparatus 1700 through discharge opening 1704. A cover 1712 on top of mower body 1702 can house batteries 1714 and an electric motor (not depicted). FIG. 17 also illustrates collapsible and foldable handles 1730 in an extended position. When the handles are fully collapsed (e.g., the red portion of the handles fully extended into the black bottom portion of the handles), collapsible and foldable handles 1730 can be folded atop mower body 1702 such that lawn maintenance apparatus 1700 occupies a volume bounded by diameters of the four wheels of lawn maintenance apparatus 1700 (e.g., as illustrated by collapsed and folded handles 1440D of FIG. 14D, supra).

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A grass mowing apparatus, comprising:
a plurality of front wheels and a plurality of rear wheels;
a mow deck;
a blade apparatus secured to the mow deck and secured to a plurality of blades, the blade apparatus configured to drive motion of the plurality of blades within an interior of the mow deck in response to a force applied to the blade apparatus;
an electric motor coupled to the blade apparatus and configured to supply the force to the blade apparatus;
a discharge chute opening on a side of the mow deck defining an opening within the mow deck; and
a bagging assembly connected to the grass mowing apparatus, the bagging assembly comprising:
a chute portion positioned within the discharge chute opening for guiding material from an interior of the mow deck into the bagging assembly, and
a bag portion coupled to the chute portion for receiving the material guided by the chute portion.

2. The grass mowing apparatus of claim 1, wherein the bag portion further comprises a forward bag portion and a rear bag portion, the forward bag portion rests upon the mow deck at least in part forward of the plurality of rear wheels and the rear bag portion is positioned in part behind the plurality of rear wheels, and further wherein material guided by the chute portion and received within the forward bag portion also rests upon the mow deck within the forward bag portion.

3. The grass mowing apparatus of claim 2, wherein the bag portion comprises at least two handles secured to the bag portion, the at least two handles including a first handle secured to the forward bag portion and a second handle secured to a dump opening lid of the rear bag portion.

4. The grass mowing apparatus of claim 3, wherein the at least two handles secured to the bag portion further comprises a third handle secured to a central region of the bag portion proximate a boundary of the forward bag portion and the rear bag portion.

5. The grass mowing apparatus of claim 1, wherein the plurality of blades comprises:
a flat cutting blade that secures to the blade apparatus near a center portion of the mow deck and extends along a length of the flat cutting blade toward a perimeter of the mow deck, wherein a width of the flat cutting blade includes a cutting edge and a non-cutting edge and wherein the width has a relatively small physical twist about the length of the flat cutting blade less than about ten degrees rotation; and
a lift cutting blade that secures to the blade apparatus near the center portion of the mow deck and extends along a length of the lift cutting blade toward the perimeter of the mow deck, wherein a width of the lift cutting blade has a relatively large physical twist about the length of the lift cutting blade greater than about fifteen degrees rotation.

6. The grass mowing apparatus of claim 1, wherein the plurality of blades further comprises a cleaning blade secured at one end to the blade apparatus near a center portion of the mow deck and extends along a length of the cleaning blade toward a perimeter of the mow deck, wherein the cleaning blade includes an interior extending portion that extends from the blade apparatus toward an interior top surface of the mow deck.

7. The grass mowing apparatus of claim 1, wherein the discharge chute opening is formed in a top surface of the mow deck and intersects, at a rear portion of the discharge chute opening, a secant line defined with respect to a perimeter of the top surface of the mow deck at a first rearward point, and intersects, at a forward portion of the discharge chute opening, the secant line at a second forward point, wherein the secant line crosses a wheel axis of one of the plurality of front wheels or of one of the plurality of rear wheels.

8. The grass mowing apparatus of claim 1, wherein the chute portion as positioned within the discharge chute opening is confined to a perimeter of the mow deck.

9. The grass mowing apparatus of claim 1, wherein:
the chute portion guides the material toward a rear portion of the bagging assembly; and
the bag portion comprises a grass flow diverter including a mechanical baffle that physically redirects flow of a portion of the material guided toward the rear portion of the bagging assembly by the chute portion into a front portion of the bagging assembly, and wherein the front portion of the bagging assembly rests at least in part on a rear portion of the mow deck.

10. The grass mowing apparatus of claim 1, wherein the bag portion further comprises a dump opening that defines a hole in the bag portion and comprises a lid that covers the dump opening of the bag portion when the bag portion is connected to the grass mowing apparatus as part of the bagging assembly, and further wherein the lid is movable to uncover the dump opening to facilitate removing contents of the bag portion via the dump opening.

11. The grass mowing apparatus of claim 10, wherein the lid includes a transparent portion facilitating visible inspection of an interior of the bag portion.

12. The grass mowing apparatus of claim 10, wherein the lid defines a surface that is positioned in a non co-planar relationship to a top surface of the bag portion

13. The grass mowing apparatus of claim 12, wherein the non co-planar relationship is defined such that the lid is positioned above the top surface of the bag portion at an upper edge of the lid and the lid is positioned flush with the top surface of the bag portion at a lower edge of the lid, wherein the upper edge and the lower edge of the lid are determined with the bagging assembly connected to the grass mowing apparatus.

14. The grass mowing apparatus of claim 1, wherein the chute portion includes a curved lower surface and a flat or substantially flat top surface as positioned within the discharge chute opening and in a direction substantially transverse to the flow of material guided from the interior of the mow deck into the bagging assembly.

15. The grass mowing apparatus of claim 1, further comprising a displaceable and replaceable cover over the discharge chute opening configured to cover and close the discharge chute opening in response to the chute portion being removed from the discharge chute opening.

16. The grass mowing apparatus of claim 1, wherein the mow deck includes a top surface including an upper peak portion and a first portion extending toward a perimeter of the mow deck from the upper peak portion, wherein the first portion has an angle to a tangent plane associated with the upper peak portion that is in a range from 12 degrees to 22 degrees.

17. The grass mowing apparatus of claim 16, further comprising a second portion at a perimeter of the mow deck and in contact with an edge of the first portion, the second portion having a second angle to the tangent plane associated with the upper peak portion that is in a second range from 35 degrees to 65 degrees.

18. A blade assembly for an electric-powered walk behind mowing machine with bagging assembly for collecting grass clippings of the mowing machine, comprising:
a central portion configured to rotate about a central axis of the central portion and includes a plurality of blade connectors comprising a first blade connector configured to be hand-secured to a removable blade;
a cutting blade connected to the first blade connector and having a length dimension extending from the central portion toward a perimeter defined by a non-secured end of the cutting blade opposite the connection to the first blade connector, and having a width dimension substantially transverse to a rotational direction that the central portion rotates about the central axis, wherein the width dimension defines a tilt about the length dimension of smaller than about ten degrees; and
a cutting lift blade connected to a second blade connector of the plurality of blade connectors and having the length dimension and the width dimension, wherein the width dimension of the cutting lift blade defines a second tilt about the length dimension of greater than about fifteen degrees.

19. The blade assembly of claim 18, further comprising a cleaning blade fastened to the central portion of the blade assembly, the cleaning blade having a profile along a length dimension thereof that extends above a blade connector of the plurality of blade connectors to which the cleaning blade is secured to the central portion.

20. The blade assembly of claim 18, further comprising at least one of:
a second cutting blade and a second cutting lift blade connected to respective blade connectors of the plurality of blade connectors, wherein the cutting lift blade and the second cutting lift blade are connected symmetrically or non-symmetrically about the central axis of the central portion;
the second cutting blade and a third cutting blade connected to respective blade connectors of the plurality of blade connectors; or
the second cutting lift blade and a third cutting lift blade connected to respective blade connectors of the plurality of blade connectors.

21. The blade assembly of claim 18, wherein the tilt about the length dimension of the cutting blade is zero or about zero degrees.

22. The blade assembly of claim 21, wherein the tilt about the length dimension of the cutting lift blade is selected from at least one of the following:
within a range of about seventeen degrees to about twenty five degrees;
within a second range of about nineteen degrees to about twenty three degrees; or
about twenty one degrees.

23. The blade assembly of claim 22, wherein the tilt about the length dimension of the cutting lift blade gradually increases along the length dimension of the cutting lift blade from about no tilt proximate the central portion to the second tilt toward a perimeter of the cutting lift blade.

24. A power equipment device, comprising:
a mow body;
a plurality of front wheels and a plurality of rear wheels secured to a front portion and a rear portion, respectively, of the mow body;
a mow deck extending from an under side of the mow body;
a blade apparatus secured to the mow body and configured to drive a plurality of blades within an interior of the mow deck in response to a force applied to the blade apparatus;
an electric motor coupled to the blade apparatus and configured to supply the force to the blade apparatus;
a handle secured to the mow body, the handle configured to fold down over the mow deck and the frame; and
a lift mechanism configured to raise and lower at least the mow deck and the mow body relative to the front wheels and rear wheels, the lift mechanism comprising:
a left-right mechanical coupling located proximate the rear wheels that couples a left-side of the lift mechanism with a right-side of the lift mechanism and causes the left-side and right-side of the lift mechanism to move together; and
a single lift handle to raise or lower the mow deck and the mow body concurrently,
wherein the power equipment device is contained within a volume defined by the diameters of the front wheels and rear wheels, in response to the lift mechanism positioned to a compact position and the handle folded down over the mow deck.

25. The power equipment device of claim 24, wherein at least one of the following:
a front of the mow deck and a forward cutting range of the blade apparatus within the mow deck extends to or beyond a rear extent of the plurality of front wheels; or
a rear of the mow deck and a rear cutting range of the blade apparatus within the mow deck extends to or beyond a forward extent of the plurality of rear wheels.

26. A bagging assembly for a walk-behind lawn mower, comprising:
a chute that removably couples to a mow deck of the walk-behind lawn mower for guiding clippings from an interior of the mow deck out of the mow deck, the chute including a bottom portion and a top portion, the bottom portion having a front opening that receives the clippings and a rear guide surface that is curved in a direction transverse to or approximately transverse to a flow of the clippings from the mow deck through the chute, and the top portion have a flat surface; and
a bag coupled to the chute to receive the clippings guided by the chute, the bag including a front portion, a rear portion, a grass flow diverter, a dump opening and a dump lid, wherein:
the chute is configured to guide the clippings to the rear portion of the bag and wherein the grass flow diverter includes a baffle that physically redirects flow of a portion of the clippings guided by the chute to the front portion of the bag,
the dump opening defines a hole in the bag and the dump lid covers the hole when the bagging assembly is coupled to the walk-behind lawn mower and uncovers the hole in response to removal of the dump lid away from the bag,
the dump lid includes a transparent cover that facilitates view of an interior portion of the bag in response to the dump lid covering the hole.

27. The bagging assembly of claim 26, wherein the dump lid when covering the hole defined by the dump opening is non-flush with a top surface of the bag.

28. The bagging assembly of claim 26, wherein the flat surface of the top portion of the chute defines a right angle or substantially right angle to a side wall of the chute.

29. The bagging assembly of claim 26, wherein the rear guide surface defines a curvature between the rear guide surface and a side wall of the chute, the curvature being selected from a group consisting of: a circular curvature, an approximately circular curvature, an elliptical curvature, an approximately elliptical curvature, a parabolic curvature and an approximately parabolic curvature.

30. The bagging assembly of claim 26, wherein the rear guide surface defines a curvature between the rear guide surface and a side wall of the chute having a radius of curvature in a range of about 0.75 to about 1.50 inches.

31. The bagging assembly of claim 30, wherein the radius of curvature is in a second range of about 1.0 to about 1.25 inches.

32. The bagging assembly of claim 26, wherein the chute and the bag define a contiguous single physical structure removably couplable to the mow deck at the front opening.

33. The bagging assembly of claim 26, wherein the bag is removably couplable to the chute and separates from the chute to facilitate dumping of clippings from the bag.

34. The bagging assembly of claim 26, wherein the bag comprises at least two handles including a first handle secured to the front portion of the bag and a second handle secured to the dump lid.

35. The bagging assembly of claim 34, further comprising a third handle secured to a central region of the bag near a middle of the front portion and the rear portion.
